(19) United States
(12) Patent Application Publication
(10) Pub. No.: US 2003/0200259 A1
(43) Pub. Date: Oct. 23, 2003

(54) Information providing system and information providing server for providing a reliable provision information

(75) Inventor: Kazuo Tsuge, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/413,541

(22) Filed: Apr. 15, 2003

(30) Foreign Application Priority Data
Apr. 18, 2002 (JP) 2002-116817

(51) Int. Cl. G06F 15/16; G06F 17/00

(52) U.S. Cl. 709/203; 707/104.1

(57) ABSTRACT

An information providing system includes an information terminal which belongs to a user and a providing server which is connected to the information terminal through a network. In this system, the providing server transmits provision information from the providing server to the information terminal through the network. When receiving an update information which is for updating the provision information and includes relation information related to the user from the information terminal, the providing server calculates an information reliability degree indicating a degree of a reliability of the update information based on at least one of the relation information and the update information. The providing server updates the provision information based on the information reliability degree and the update information.

### BACKGROUND OF THE INVENTION

1. Field of the Invention

The present invention relates to an information providing system and information providing server, and more particularly, relates to the information providing system and the information providing server for providing a provision information with high reliability.

2. Description of the Related Art

In recent years, due to the propagation of the Internet, a service provider (hereafter, referred to as a provider) can provide a collected information as a provision information in a form of electronic data, to a service user (hereafter, referred to a user) who contracts with the provider. Since the information (provision information) is frequently changed in real time, the provider must update the provision information for each change. So, Japanese Laid Open Patent Application (JP-A, 2001-306417) and Japanese Laid Open Patent Application (JP-A, 2000-10471) disclose a system in which the user itself can update the provision information (for example, the information related to a map).

However, the mechanism, in which the user itself freely updates the provision information, may cause the provision information distorted by a miss of the user or a wrongful user to be provided to a third party (a different user).

As the related technique, “the network and the information transmission system which used a geographic information system” is disclosed in the Japanese Laid Open Patent Application (JP-A 2001-306417). This network and an information transmission system are composed of map information, a server and a mail server. Here, the server establishes an icon in the optional place on the map. The server does the registration of the icon, the renewal and the deletion of the information. The mail server sets the E-mail address which corresponds to the icon based on the request from the server. This network and the information transmission system can be transmitted to the E-mail address to have set registration, the renewal and the deletion of the information to every the icon. It can read contents every icon by the E-mail. The object which sets an icon is the disaster place, a building site, a public facilities, a building, an emporium, a tourist resort, a showplace, a hotel and a hospital and so on. The purpose of this technique is that a user is made to be able to simply renew the map information which was exhibited onto the Internet and to make the existence or non-existence of the renewal clear.

“The map display unit and the method” is disclosed in the Japanese Laid Open Patent Application (JP-A 2000-10471). This map display unit has a map display section, a user information editorial section and a user information storage section. Here, the map display section displays a map. The user information editorial section generates the user information which related a place on the map which the user specified and a user diagram as the design which the user set. The user information storage section stores the user information which was generated by the user information editorial section. Then, the map display section refers to the user information which is stored in the user information storage section and displays a user diagram in the place on the map. The user information may contain diagram definition information and action information. The diagram definition information defines a user diagram. The action information is related by the user diagram and defines the action which the user set. When the user choose the user diagram which is displayed on the map by fixed operation, the map display section executes an action. The action is defined by the action information which was related by the user diagram. The purpose of this technique is to improve the utility value of the map display unit which used a computer.

“The navigation equipment and the method of renewing a map” is disclosed in the Japanese Laid Open Patent Application (JP-A 2001-194163). This navigation equipment has map data, a current position detection means, an output means, a communication means, an un-carried road detection means, an un-carried road accumulation means, an un-carried road data management means and a navigation means. Here, the map data stores the map information which contains a road. The current position detection means detects a current position. The output means displays a map and a current position. The communication means communicates with the host computer. The un-carried road detection means detects the position or the course of the road which isn't contained in the map information based on the adjustment of the map information and the current position. The un-carried road accumulation means accumulates the position or the course of the road which was detected by the un-carried road detection means as the un-carried road data. The un-carried road data management means judges whether or not the un-carried road data, which was accumulated by the un-carried road accumulation means, is an un-carried road based on the judgment parameter information. It notifies the existence of the un-carried road to the host computer. The map renewal means downloads the map data in case that there are the certain map data and also map data which is newer than it when a notice is transmitted to the host computer from the un-carried road data management means. Here, the notice is the notice which shows that the un-carried road exists. The certain map data is the map data which carries the road data showing the un-carried road. The purpose of this technique is to detect automatically the road which doesn't exist in the map data, to renew map data in the timing which is necessary and then to provide it for the user as the map data of the sharing.

### SUMMARY OF THE INVENTION

Therefore, an object of the present invention is to provide an information providing system and an information providing server that can provide a reliable provision information.

Another object of the present invention is to provide an information providing system and an information providing server which can updates the provision information based on the information received from users of the system and its reliability.

In order to achieve an aspect of the present invention, the present invention provides an information providing system including: an information terminal which belongs to a user; and a providing server which is connected to the information terminal through a network. In this system, the providing server transmits provision information from the providing server to the information terminal through the network. When receiving an update information which is for updating the provision information and includes relation information related to the user from the information terminal, the providing server calculates an information reliability degree indicating a degree of a reliability of the update information based on at least one of the relation information and the update information. The providing server updates the provision information based on the information reliability degree and the update information.

In the information providing system, the provision information is map information related to a map.

In the information providing system, the relation information includes user position information indicating at least one of a locus of a position at which the user transmits the update information through the information terminal and a position at which the user is located, and an indication position information indicating a position which the user indicates through the information terminal. When receiving the update information from the information terminal, the providing server calculates the information reliability degree based on one of a shortest distance between the user position and the indication position and a fact whether or not the user can be moved to the indication position from the user position in the shortest distance.

In order to achieve another aspect of the present invention, the present invention provides an information providing server including: a provider section which provides provision information for an information terminal belonging to a user by transmitting the provision information through a network; and a provision database which stores the provision information. In the server, when receiving an update information which is for updating the provision information and includes relation information related to the user from the information terminal, the providing section calculates an information reliability degree indicating a degree of a reliability of the update information based on at least one of the relation information and the update information. The providing section updates the provision information based on the information reliability degree and the update information.

In the information providing server, wherein the provision information is map information related to a map.

In the information providing server, the relation information includes user position information indicating at least one of a locus of a position at which the user transmits the update information through the information terminal and a position at which the user is located, and an indication position information indicating a position which the user indicates through the information terminal. The providing section calculates the information reliability degree based on one of a shortest distance between the user position and the indication position and a fact whether or not the user can be moved to the indication position from the user position in the shortest distance, when receiving the update information from the information terminal.

The information providing server, further including: a positional correlation value database which relates the shortest distance and a positional correlation value. In the server, the positional correlation value is a value indicating the correlation between the user position and the indication position. The providing section refers to the positional correlation value database and calculates the information reliability degree, when receiving the update information from the information terminal.

The information providing server, further including: a user reliability information database which relates the user identifier to identify the user and a user reliability degree indicating a degree of a reliability of the user. In the server, the relation information includes the user identifier. The providing section refers to the user reliability information database and calculates the information reliability degree.

The information providing server, further including: an update content reliability information database which stores an information reliability history of the update information in order to update the provision information. In the server, the providing section refers to the update content reliability information database, calculates the information reliability degree, and then updates the provision information based on the information reliability degree and the update information, when receiving the update information from the information terminal.

In the information providing server, the provider section calculates the information reliability degree based on a similarity between the provision information and the update information. The information reliability degree is increased or decreased based on the similarity.

In the information providing server, the update information further includes a content information indicating a content. The update content reliability information database stores a content information number and the content information correlated to the information reliability history. The similarity indicates a degree of the similarity between the provision information and the content information. The provider section increases the content information number, and refers to the update content reliability information database, and then calculates the information reliability degree, when receiving the update information having the content information similar to the provision information from the information terminal.

The information providing server, further including: an user reliability information database which relates a user reliability history and the user identifier in order to identify the user. The user reliability history is the history of the user reliability indicating the degree of the reliability of the user. The relation information includes the user identifier. The provider section further refers to the user reliability information database, and calculates the information reliability degree so that the information reliability degree is reflected in the user reliability history.

In the information providing server, the provider section transmits the updated provision information to the information terminal. The updated provision information includes an update reliability degree-indicating the degree of the reliability of the updated provision information.

In the information providing server, the updated provision information includes an icon corresponding to the update information, and is displayed on the information terminal. The update reliability degree is displayed on the information terminal through varieties of one of the icon and color around the icon.

In the information providing server, the updated provision information includes the icon corresponding to the update information, and is displayed on the information terminal. The update reliability degree is displayed on the information terminal by using at least one of a numeral and a character that are related to the icon.

In the information providing server, the provider section transmits an update report indicating that the provision information was updated, to the information terminal of the user related to the update information.

In the information providing server, the related user is the user located at one of the indication position included in the update information and a vicinity of the indication position. The provider section obtains the user position of the related user from the information terminal of the related user. The provider section refers to the user reliability information database, and transmit the update report to the information terminal of the related user, when the user position represents one of the indication position and the vicinity thereof.

In the information providing server, the related user is the user who transmits to the provider section the update information having the user identifier with regard to the provision information through the information terminal. The provision information relates the user identifier to the information reliability history and stores in the update content reliability information database. The provider section refers to the update content reliability information database and thereby transmits the update report to the information terminal of the related user, when the provision information is updated.

In the information providing server, the related user is the user who preliminarily transmites to the provider section a reception request indicating that the related user requests to receive the update report with regard to the provision information through the information terminal. The provider section relates the user identifier of the related user requesting the reception request of the provision information in advance to the reception request, and stores the reception request in the user reliability information database, when the related user requests the reception request in advance. The provider section refers to the user reliability information database and thereby transmits the update report to the information terminal of the related user, when the update information is updated.

In the information providing server, the provider section sets in advance a setting reliability degree as a threshold with respect to the information reliability degree in order to update the provision information, and updates the provision information when the information reliability degree exceeds the setting reliability degree.

In order to achieve still another aspect of the present invention, the present invention provides an information providing method including the steps of: (a) providing provision information stored in a provision database for an information terminal belonging to a user by transmitting the provision information through a network; (b) when receiving an update information which is for updating the provision information and includes relation information related to the user from the information terminal, calculating an information reliability degree indicating a degree of a reliability of the update information based on at least one of the relation information and the update information; and (c) updating the provision information based on the information reliability degree and the update information.

In the information providing method, the provision information is map information related to a map.

In the information providing method, the relation information includes user position information indicating at least one of a locus of a position at which the user transmits the update information through the information terminal and a position at which the user is located, and an indication position information indicating a position which the user indicates through the information terminal. In the step (b), the information reliability degree is calculated based on one of a shortest distance between the user position and the indication position and a fact whether or not the user can be moved to the indication position from the user position in the shortest distance, when receiving the update information from the information terminal.

In the information providing method, the information reliability degree is calculated based on a positional correlation value database, when receiving the update information from the information terminal in the step (b). The positional correlation value database relates the shortest distance and a positional correlation value. The positional correlation value is a value indicating the correlation between the user position and the indication position.

In the information providing method, the relation information includes the user identifier. The information reliability degree is calculated based on a user reliability information database which relates the user identifier to identify the user and a user reliability degree indicating a degree of a reliability of the user in the step (b).

In the information providing method, when receiving the update information from the information terminal, the information reliability degree is calculated based on an update content reliability information database which stores an information reliability history of the update information in order to update the provision information in the step (b). The provision information is updated based on the information reliability degree and the update information in the step (c).

In the information providing method, the information reliability degree is calculated based on a similarity between the provision information and the update information. The information reliability degree is increased or decreased based on the similarity.

In the information providing method, the update information further includes a content information indicating a content. The update content reliability information database stores a content information number and the content information correlated to the information reliability history. The similarity indicates a degree of the similarity between the provision information and the content information. The content information number is increased, and the information reliability degree is calculated based on the update content reliability information database, when receiving the update information having the content information similar to the provision information from the information terminal in the step (b).

In the information providing method, the relation information includes the user identifier. The information reliability degree is calculated further based on an user reliability information database which relates a user reliability history and the user identifier in order to identify the user in the step (b). The user reliability history is the history of the user reliability indicating the degree of the reliability of the user. The information reliability degree is reflected in the user reliability history.

In the information providing method, the updated provision information from the step (c) is transmitted to the information terminal in the step (a). The updated provision information includes an update reliability degree indicating the degree of the reliability of the updated provision information.

In the information providing method, the updated provision information from the step (c) includes an icon corresponding to the update information, and is displayed on the information terminal. The update reliability degree is displayed on the information terminal through varieties of one of the icon and color around the icon.

In the information providing method, the updated provision information from the step (c) includes the icon corresponding to the update information, and is displayed on the information terminal. The update reliability degree is displayed on the information terminal by using at least one of a numeral and a character that are related to the icon.

In the information providing metho, an update report indicating that the provision information was updated is transmitted to the information terminal of the user related to the update information in the step (a).

In the information providing method, the related user is the user located at one of the indication position included in the update information and a vicinity of the indication position. The user position of the related user is obtained from the information terminal of the related user, and the update report is transmitted based on the user reliability information database to the information terminal of the related user, when the user position represents one of the indication position and the vicinity thereof in the step (a).

In the information providing method, the related user is the user who transmits to the provider section the update information having the user identifier with regard to the provision information through the information terminal. The user identifier is related to the information reliability history and is stored in the update content reliability information database in the step (b). The update report is transmitted to the information terminal of the related user based on the update content reliability information database in the step (a), when the provision information is updated in the step (c).

In the information providing method, the related user is the user who preliminarily transmits to the provider section a reception request indicating that the related user requests to receive the update report with regard to the provision information through the information terminal. The reception request is related to the user identifier of the related user requesting the reception request of the provision information in advance, and is stored in the user reliability information database in the step (b), when the related user requests the reception request in advance. The update report is transmitted to the information terminal of the related user based on the user reliability information database in the step (a), when the update information is updated in the step (c).

In the information providing method, a setting reliability degree as a threshold with respect to the information reliability degree in order to update the provision information is set in advance, and the provision information is updated when the information reliability degree exceeds the setting reliability degree in the step (c).

In order to achieve yet still another aspect of the present invention, the present invention provides a computer program product embodied on a computer-readable medium and including code that, when executed, causes a computer to perform the following: (d) providing provision information stored in a provision database for an information terminal belonging to a user by transmitting the provision information through a network; (e) when receiving an update information which is for updating the provision information and includes relation information related to the user from the information terminal, calculating an information reliability degree indicating a degree of a reliability of the update information based on at least one of the relation information and the update information; and (f) updating the provision information based on the information reliability degree and the update information.

In the computer program product, the provision information is map information related to a map.

In the computer program product, the relation information includes user position information indicating at least one of a locus of a position at which the user transmits the update information through the information terminal and a position at which the user is located, and an indication position information indicating a position which the user indicates through the information terminal. In the step (e), the information reliability degree is calculated based on one of a shortest distance between the user position and the indication position and a fact whether or not the user can be moved to the indication position from the user position in the shortest distance, when receiving the update information from the information terminal.

In the computer program product, the information reliability degree is calculated based on a positional correlation value database, when receiving the update information from the information terminal in the step (e). The positional correlation value database relates the shortest distance and a positional correlation value. The positional correlation value is a value indicating the correlation between the user position and the indication position.

In the computer program product, the relation information includes the user identifier. The information reliability degree is calculated based on a user reliability information database which relates the user identifier to identify the user and a user reliability degree indicating a degree of a reliability of the user in the step (e).

In the computer program product, when receiving the update information from the information terminal, the information reliability degree is calculated based on an update content reliability information database which stores an information reliability history of the update information in order to update the provision information in the step (e). The provision information is updated based on the information reliability degree and the update information in the step (f).

In the computer program product, the information reliability degree is calculated based on a similarity between the provision information and the update information. The information reliability degree is increased or decreased based on the similarity.

In the computer program product, the update information further includes a content information indicating a content. The update content reliability information database stores a content information number and the content information correlated to the information reliability history. The similarity indicates a degree of the similarity between the provision information and the content information. The content information number is increased, and the information reliability degree is calculated based on the update content reliability information database, when receiving the update information having the content information similar to the provision information from the information terminal in the step (e).

In the computer program product, the relation information includes the user identifier. The information reliability degree is calculated further based on an user reliability information database which relates a user reliability history and the user identifier in order to identify the user in the step (e). The user reliability history is the history of the user reliability indicating the degree of the reliability of the user. The information reliability degree is reflected in the user reliability history.

In the computer program product, the updated provision information from the step (f) is transmitted to the information terminal in the step (d). The updated provision information includes an update reliability degree indicating the degree of the reliability of the updated provision information.

In the computer program product, the updated provision information from the step (f) includes an icon corresponding to the update information, and is displayed on the information terminal. The update reliability degree is displayed on the information terminal through varieties of one of the icon and color around the icon.

In the computer program product, the updated provision information from the step (f) includes the icon corresponding to the update information, and is displayed on the information terminal. The update reliability degree is displayed on the information terminal by using at least one of a numeral and a character that are related to the icon.

In the computer program product, an update report indicating that the provision information was updated is transmitted to the information terminal of the user related to the update information in the step (d).

In the computer program product, the related user is the user located at one of the indication position included in the update information and a vicinity of the indication position. The user position of the related user is obtained from the information terminal of the related user, and the update report is transmitted based on the user reliability information database to the information terminal of the related user, when the user position represents one of the indication position and the vicinity thereof in the step (d).

In the computer program product, the related user is the user who transmits to the provider section the update information having the user identifier with regard to the provision information through the information terminal. The user identifier is related to the information reliability history and is stored in the update content reliability information database in the step (e). The update report is transmitted to the information terminal of the related user based on the update content reliability information database in the step (d), when the provision information is updated in the step (f).

In the computer program product, the related user is the user who preliminarily transmits to the provider section a reception request indicating that the related user requests to receive the update report with regard to the provision information through the information terminal. The reception request is related to the user identifier of the related user requesting the reception request of the provision information in advance, and is stored in the user reliability information database in the step (e), when the related user requests the reception request in advance. The update report is transmitted to the information terminal of the related user based on the user reliability information database in the step (d), when the update information is updated in the step (f).

In the computer program product, a setting reliability degree as a threshold with respect to the information reliability degree in order to update the provision information is set in advance, and the provision information is updated when the information reliability degree exceeds the setting reliability degree in the step (f).

In order to achieve further still another aspect of the present invention, the present invention provides an information terminal used by a user and connected to a provider server through a network including: a first screen portion which displays provision information received from the provider server; a second screen portion which displays at least one of a plurality of symbols and a plurality of icons to update the provision information in the first screen portion; a control section which updates provision information in the first screen portion based on inputted at least one of the plurality of symbols and the plurality of icons and generates update information including an updated data corresponding to the update and relation information related to the user; and a transmitting section which transmits the update information to the provider server. In the terminal, the provider server updates the provision information in the provider server based on the update information.

In the information terminal, the relation information includes user position information indicating at least one of a locus of a position at which the user transmits the update information through the information terminal and a position at which the user is located, and an indication position information indicating a position which the user indicates through the information terminal. The provision information is map information related to a map.

### BRIEF DESCRIPTION OF THE DRAWINGS

FIG. 1 is a block diagram showing the configuration of the information providing system in the present invention;

FIG. 2 is a block diagram showing the configuration of the information terminal;

FIG. 3 is a view showing a screen to be displayed on the input unit;

FIG. 4 is a block diagram showing the configuration of the providing unit;

FIG. 5 is a view showing the information stored in the positional correlation value database;

FIG. 6 is a view showing the information stored in the user reliability information database;

FIG. 7 is a view showing the information stored in the update content reliability information database;

FIG. 8 is a first half of flowchart showing the operations of the information providing system and the information providing server;

FIG. 9 is a second half of a flowchart showing the operations of the information providing system and the information providing server;

FIG. 10 is a flowchart for obtaining the user position information executed by the information terminal;

FIG. 11 is a flowchart for obtaining the user position information executed by the provider server;

FIG. 12 is a first part of a flowchart for uploading the map data executed by the provider server;

FIG. 13 is a second part of a flowchart for uploading the map data executed by the provider server;

FIG. 14 is a third part of a flowchart for uploading the map data executed by the provider server;

FIG. 15 is a fourth part of a flowchart for uploading the map data executed by the provider server;

FIG. 16 is a fifth part of a flowchart for uploading the map data executed by the provider server;

FIG. 17 is a last part of a flowchart for uploading the map data executed by the provider server;

FIG. 18 is a first half of a flowchart for downloading the map data executed by the information terminal and the provider server;

FIG. 19 is a second half of a flowchart for downloading the map data executed by the information terminal and the provider server;

FIG. 20 is a view showing a screen to be displayed on the information terminal;

FIG. 21 is another view showing a screen to be displayed on the information terminal;

FIG. 22 is stil another view showing a screen to be displayed on the information terminal; and

FIG. 23 is yet stil another view showing a screen to be displayed on the information terminal.

### DESCRIPTION OF THE PREFERRED EMBODIMENTS

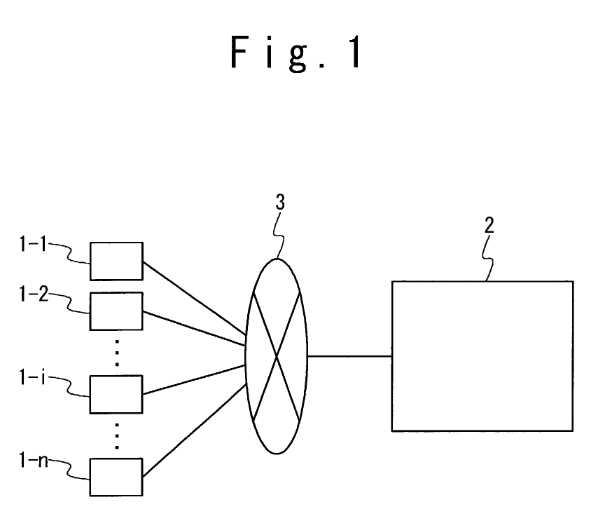

An embodiment of an information providing system according to the present invention will be described below with reference to the attached drawings. FIG. 1 is a block diagram showing the configuration of the information providing system in the present invention. The information providing system in the present invention includes a plurality of information terminals 1-1 to 1-n (n=1, 2, 3 to n) and a providing unit 2. The information terminals 1-1 to 1-n and the providing unit 2 are connected to a network 3. The information terminals 1-1 to 1-n belong to users (contractors) who contract in advance with a provider. The providing unit 2 belongs to the provider (the providing dealer) and transmits a provision information through the network 3 to the information terminals 1-1 to 1-n and provides to the user. This providing unit 2, when receiving an update information from the information terminal (1-i) (i=1, 2, 3 to n), automatically calculates a reliability degree indicative of a degree of a reliability of the update information, and updates the provision information based on the update information if the calculated reliability degree is higher than a set reliability degree (threshold) (if it exceeds the threshold or it is equal to or higher than the threshold). Thus, the information providing system in the present invention can provide the reliable provision information. As the provision information, for example, there are a map information related to a map, an article price information related to an article price, an event information related to an event and a new article information related to a new article. This information providing system in the present invention provides, for example, a map data indicative of a map as the map information.

The map data contains a business information indicative of a business carried out by the dealer. As the dealer, for example, there are a dealer who carries out a business in a building (inside a house), a dealer who carries out a business inside and outside a house, and a dealer who carries out a business outside a house. As the business (the business information) carried out by the dealer in the building (inside the house), there are exemplified a shop, a building, a restaurant and a convenience store. As the dealer, there are exemplified the mangers of the shop, the building, the restaurant and the convenience store. An event is exemplified as the business (the business information) carried out by the dealer inside and outside the house, and an event dealer is exemplified as the dealer. A construction is exemplified as the business (the business information) carried out by the dealer outside the house, and a road constructor is exemplified as the dealer. Also, a no thoroughfare is exemplified as the business (the business information) carried out by the dealer outside the house, and the road constructor and a police are exemplified as the dealer.

The provider calls the user, for example, a member. Presently, the number of the members is n. The members include general members, special members and investigators. The general member preliminarily contracts (a personal contract) with the provider, in order to use the map data. A user ID to identify the user (contractor) and a password to identify the general member among the contractors are given to the general member contracting the personal contract by the dealer. The special member is the dealer indicated by the business information. In order to advertise the business information to the general members, the special member preliminarily contracts (a juridical person contract) with the provider. The user ID to identify the user (contractor) and a password to identify the special member from the contractors are given to the special member by the provider. The investigator is the staff preliminarily contracting with the provider in order to examine the roads and the dealers so that the map data is updated by the providing unit 2, and the above-mentioned provider. The user ID to identify the user (contractor) and a password to identify the investigator from the contractors are given to the investigator by the provider.

The providing unit 2 has a computer program to provide the map data. The information terminal 1-i (i=1, 2, 3 to n) belongs to the user, and it has a computer program to use the map data. The computer program of the information terminal 1-i is installed in advance in the information terminal 1-i, as a terminal software corresponding to the computer program of the providing unit 2.

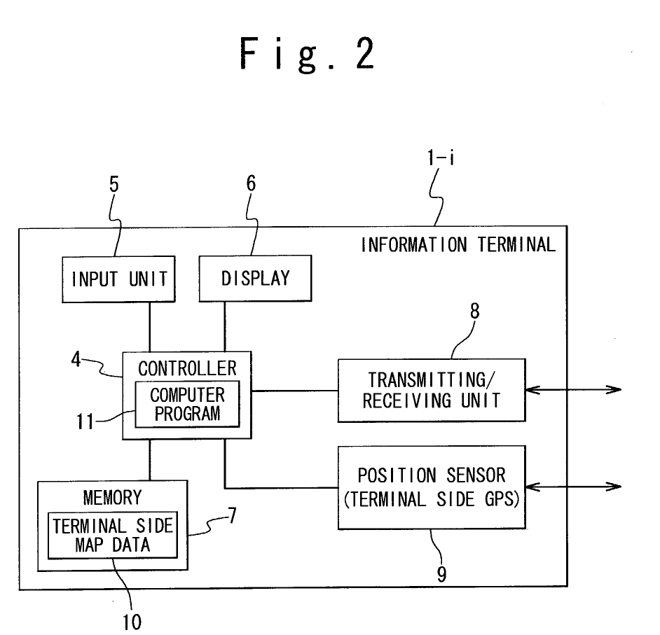

FIG. 2 is a block diagram showing the configuration of the information terminal 1-i (i=1, 2, 3 to n). The information terminal 1-i includes a controller 4, an input unit 5, a display 6, a memory 7, a transmitting/receiving unit 8 and a position sensor 9. The input unit 5, the display 6, the memory 7, the transmitting/receiving unit 8 and the position sensor 9 are connected to the controller 4. The information terminal 1-i is the information processor exemplified as a portable terminal. A portable telephone is exemplified as the information terminal 1-i (the portable terminal) having the position sensor 9. As the position sensor 9, GPS (Global Positioning System) is exemplified in order to know the latitude/longitude as a position. In this embodiment, the position sensor 9 is referred to as a terminal side GPS 9. The controller 4 has a computer program 11 that is the above-mentioned computer program of the information terminal 1-i. The memory 7 stores a terminal side map data 10 and an icon type corresponding to the above-mentioned business information. Also, the memory 7 stores in advance the above-mentioned user ID and the abovementioned password. The terminal side map data 10 is the above-mentioned map data provided by the provider (the providing unit 2) when the user downloads by using the information terminal 1-i.

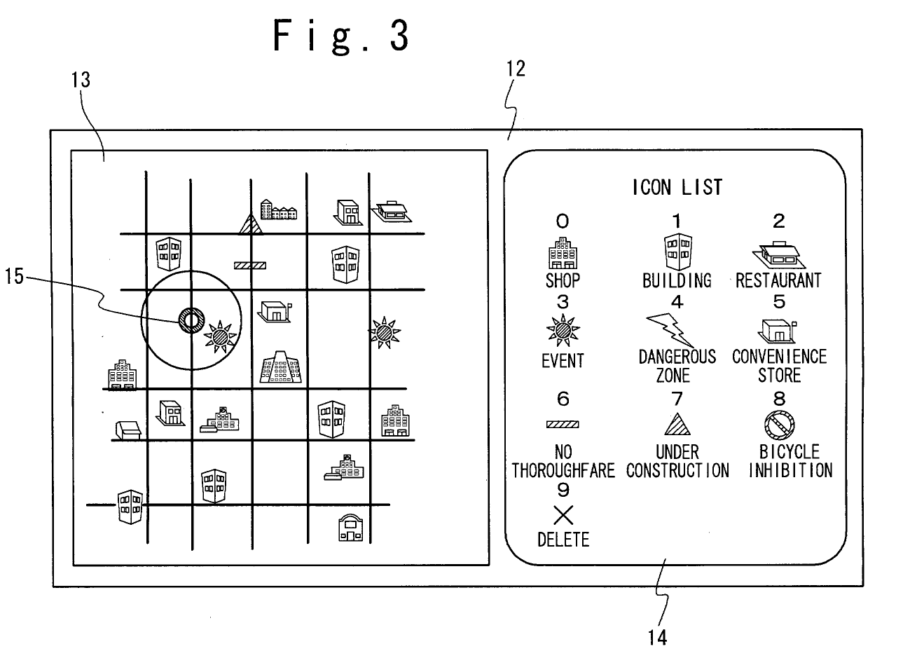

FIG. 3 is a view showing a screen 12 to be displayed on the input unit 5. The screen 12 includes: a screen 13 where the terminal side map data 10 is displayed on the input unit 5; and a screen 14 where the icon type is displayed as an icon list on the input unit 5. The screen 12 is displayed on the display 6 by the controller 4 when the user operates the input unit 5. On the screen 14, the icon list includes the icon indicative of the above-mentioned business information, an icon number to identify the icon, and an icon notification to inform the user of the icon by using a character.

For example, if the icon represents “Shop”, an icon number corresponding to that icon is “0”, and an icon notification corresponding to that icon is “Shop”. If the icon represents “Building”, an icon number corresponding to that icon is “1”, and an icon notification corresponding to that icon is “Building”. If the icon represents “Restaurant”, an icon number corresponding to that icon is “2”, and an icon notification corresponding to that icon is “Restaurant”. If the icon represents “Event”, an icon number corresponding to that icon is “3”, and an icon notification corresponding to that icon is “Event”. If the icon represents “Dangerous Zone”, an icon number corresponding to that icon is “4”, and an icon notification corresponding to that icon is “Dangerous Zone”.

Also, if the icon represents “Convenience Store”, an icon number corresponding to that icon is “5”, and an icon notification corresponding to that icon is “Convenience Store”. If the icon represents “No thoroughfare”, an icon number corresponding to that icon is “6”, and an icon notification corresponding to that icon is “No thoroughfare”. If the icon represents “Under Construction”, an icon number corresponding to that icon is “7”, and an icon notification corresponding to that icon is “Under Construction”. If the icon represents “Bicycle Inhibition”, an icon number corresponding to that icon is “8”, and an icon notification corresponding to that icon is “Bicycle Inhibition”. If the icon represents the delete (removal) of the icon from on the map, an icon number corresponding to that icon is “9”, and an icon notification corresponding to that icon is “x”.

On the map indicated by the terminal side map data 10, the above-mentioned icon type (the icon that is the business information indicative of the business) is placed at the position corresponding to the latitude/longitude at which the abovementioned business is located. Here, the position at which the icon type is placed is referred to as an icon position, and the icon position is represented by the latitude/longitude. On the map indicated by the terminal side map data 10, a user position 15 indicative of the position at which the user is located (indicative of the locus at which the user is located) is placed by the controller 4. Here, the user position 15 is represented by the latitude/longitude.

For example, let us suppose that an event is discovered inside or outside a house near the user when the user is moving. The user operates the input unit 5 of the information terminal 1-i (the portable telephone) so that the controller 4 of the information terminal 1-i displays the screen 12 (the screen 13 or 14) on the display 6 based on the action of the input unit 5 of the user. If on the screen 13, there is not the icon indicative of “Event” in the vicinity of the user position 15 on the map indicated by the terminal side map data 10, the user can use the information terminal 1-i to thereby place the icon type (the icon “Event”) at the corresponding position near the user position 15.

In this case, the user operates the input unit 5 of the information terminal 1-i and selects the icon number “3” contained in the icon type on the screen 14. The controller 4 displays the icon indicative of “Event” corresponding to the selected icon number “3” on the map indicated by the terminal side map data 10 on the screen 13 (on the display 6). The user operates the input unit 5 (by using a numeral key and a direction key of the portable telephone) to thereby move the icon “Event” displayed on the map to the corresponding position near the user position 15 on the map so that the icon “Event” is placed in the vicinity of the user position 15 on the map indicated by the terminal side map data 10. If the location where the icon “Event” is placed is determined, the user operates the input unit 5 (pushes down a determination key of the portable telephone), and the controller 4 thereby places the icon “Event” at the corresponding position near the user position 15 on the map indicated by the terminal side map data 10.

The user can reflect the icon type (the icon “Event”) newly placed on the map indicated by the terminal side map data 10, for the terminal side map data 10 and hold (store) it. In this case, the user operates the input unit 5, and the controller 4 thereby reflects the newly placed icon type (the icon “Event”) for the terminal side map data 10 and stores in the memory 7. Also, in order to update the map data provided by the providing unit 2 so that many users can know the event, the user can upload to the providing unit 2 the update information having the icon type (the icon “Event”) newly placed on the map indicated by the terminal side map data 10.

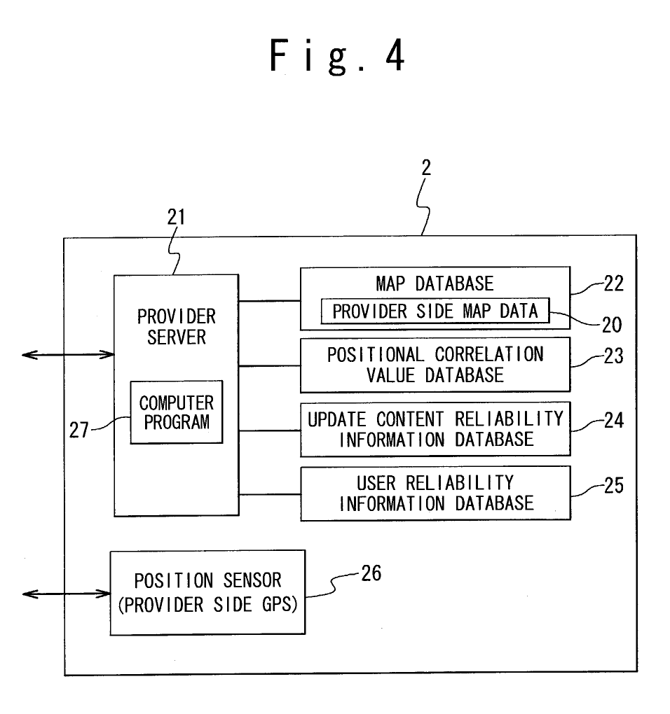

FIG. 4 is a block diagram showing the configuration of the providing unit 2. The providing unit 2 includes a provider server 21, a map database 22, a positional correlation value database 23, an update content reliability information database 24, a user reliability information database 25 and a position sensor 26. The provider server 21 is the computer for providing a provider side map data 20 and has a computer program 27, which is the computer program of the providing unit 2. The position sensor 26 is exemplified as GPS. In this embodiment, the position sensor 26 is referred to as a provider side GPS 26. The map database 22 stores the provider side map data 20 as the above-mentioned map data. The providing unit 2 may be a server (providing server) which includes the provider server 21 with the computer program 27, the map database 22 with the provider side map data 20, the positional correlation value database 23, the update content reliability information database 24, the user reliability information database 25 and the position sensor 26.

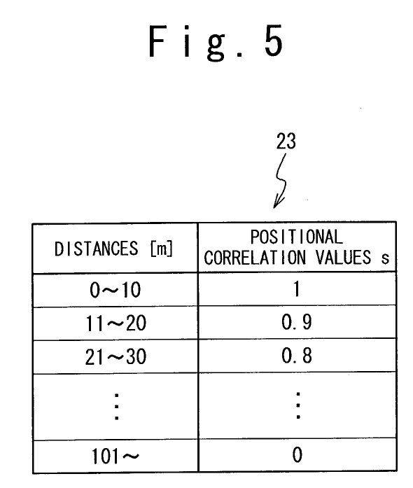

FIG. 5 is a view showing the information stored in the positional correlation value database 23. The positional correlation value database 23 stores therein a plurality of distances (m) and a plurality of positional correlation values s as the information. The positional correlation value s is correlated to the distance (m). The distance (m) is represented as a preset distance range. The range of the distance is represented, for example, as 0 to 10, 11 to 20, 21 to 30 and 101 to . . . . This distance (m) is used as a material to determine the positional correlation value s when the provider server 21 calculates the shortest distance between an icon position (latitude/longitude) and the user position 15 (latitude/longitude). The positional correlation value s is the value indicative of the correlation between the icon position (latitude/longitude) and the user position 15 (latitude/longitude). It is used as a material from which the provider server 21 judges the reliability degree of the update information from the information terminal 1-i. This positional correlation value s is represented between 0 and 1. This becomes smaller as the distance (m) is longer. For example, the positional correlation value s is 1 in the range of the distance (m) between 0 and 10. The positional correlation value s is 0.9 in the range of the distance (m) between 11 and 20. And, the positional correlation value s is 0 in the distance (m) of 101 and more.

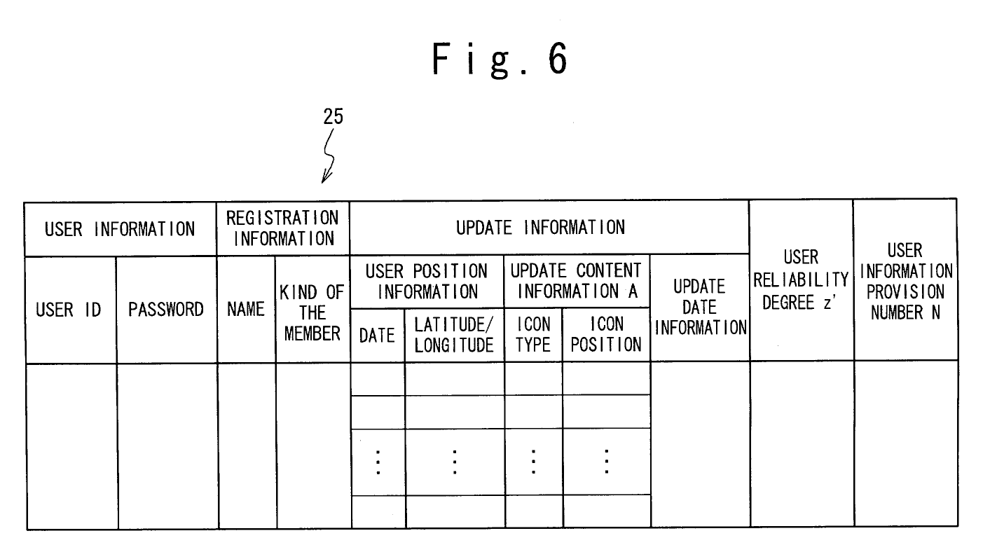

FIG. 6 is a view showing the information stored in the user reliability information database 25. The user reliability information database 25 stores a user information, a registration information, an update information, a user reliability degree z′ and a user information provision number N, which are correlated to one another, as the information for each user. The user information is the information (user identifier) related to the user, and it includes the user ID and the password as mentioned above. The registration information is the information related to the attribute of the user. For example, it includes a name of the user and the kind of the member (the general member, the special member or the investigator) when the user contracts with the provider. The user information is transmitted when the information terminal 1-i accesses the provider server 21. The user information (and the registration information) stored in the user reliability information database 25 is used as the material to recognize the kind of the member on the basis of the user information from the information terminal 1-i.

The update information is the information transmitted from the information terminal 1-i, and it includes a user position information, an update content information A and an update date information. The user position information includes the user position (latitude/longitude) corresponding to the user position 15 (the displayed user position 15), the date when the controller 4 of the information terminal 1-i generates the user position information, and the user identifier (for example, the abovementioned user ID) to identify the user located at the user position (latitude/longitude). The update content information A includes the icon type and the icon position (latitude/longitude). The icon position (latitude/longitude) included in the update content information A is the indication position indicative of the position, which the user indicates through the information terminal 1-i. The update date information indicates the date when the controller 4 of the information terminal 1-i generates the update information. The user information provision number N indicates the number (the number of times) when the user transmits the update information by using the information terminal 1-i in order to update the provider side map data 20. Also, it indicates the number (the number of times) when the provider server 21 receives the update information from the information terminal 1-i and stores in the user reliability information database 25. This user information provision number N is represented by 1, 2, 3, . . . . Presently, the number of the update information stored in the positional correlation value database 23 is N. Those N update information are used as an information update history when the information terminal 1-i was used to previously transmit the update information.

The user reliability degree z′ is the reliability degree indicative of the degree of the reliability of the user. It is used as a material from which the provider server 21 judges the reliability degree of the update information from the information terminal 1-i on the basis of the reliability degree of the user. This user reliability degree z′ is the user reliability degree stored by the provider server 21 when the provider server 21 calculates a user reliability degree z with regard to an N-th update information. That is, this user reliability degree z is the user reliability degree stored in the user reliability information database 25 before the provider server 21 calculates a user reliability degree z with regard to an (N+1)-th update information.

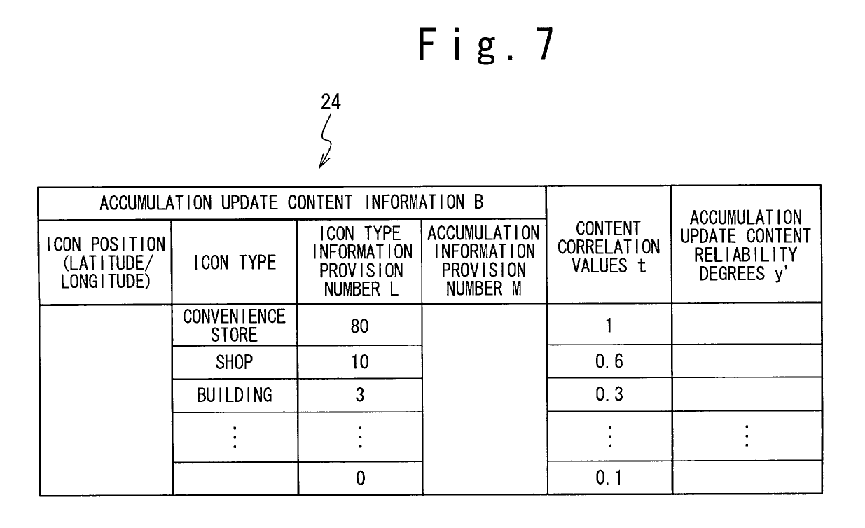

FIG. 7 is a view showing the information stored in the update content reliability information database 24. The update content reliability information database 24 stores a plurality of accumulation update content information B, content correlation values t and accumulation update content reliability degrees y′, which are correlated to one another, as the information for each latitude/longitude on the map indicated by the provider side map data 20. The accumulation update content information B includes: the latitude/longitude on the map indicated by the provider side map data 20; the icon type placed at the position corresponding to the latitude/longitude on the map indicated by the provider side map data 20; an icon type information provision number L; and an accumulation information provision number M. The latitude/longitude included in the accumulation update content information B is referred to as the icon position since the icon type is placed at the position corresponding to the latitude/longitude on the map indicated by the provider side map data 20.

As for the arbitrary latitude/longitude, there are the plurality of content correlation values t, accumulation update content reliability degrees y′, icon types contained in the accumulation update content information B, and information provision numbers by icon type L. The icon type information provision number L indicates the number of the information provided by the user for each icon type as for the arbitrary latitude/longitude, and it is correlated to the icon type included in the accumulation update content information B. For example, if the icon type included in the accumulation update content information B represents “Convenience Store”, an icon type information provision number L of that icon type is “80”. If the icon type included in the accumulation update content information B represents “Shop”, an icon type information provision number L of that icon type is “10”. If the icon type included in the accumulation update content information B represents “Building”, an icon type information provision number L of that icon type is “3”. The accumulation information provision number M indicates the accumulation of the numbers of the information provided by the user as for the arbitrary latitude/longitude on the map indicated by the provider side map data 20. That is, it indicates the accumulation (total) of the icon type information provision numbers L correlated to the icon type as for the arbitrary latitude/longitude.

The content correlation value t is the value indicative of the correlation between the update content information A and the accumulation update content information B, and it is used as the material from which the provider server 21 judges the reliability degree of the update information from the information terminal 1-i. The content correlation value t implies the similar degree indicative of the degree of the similarity between the update content information A and the accumulation update content information B. This content correlation value t is correlated to the icon type included in the accumulation update content information B and the icon type information provision number L. The content correlation value t is represented, for example, between 0.1 and 1. It becomes greater as the content (the icon type indicative of the dealer) becomes closer. The content correlation value t is determined by the provider server 21, for example, on the basis of the icon type information provision number L. It is updated by the provider server 21 for each change in the icon type information provision number L. For example, as for the arbitrary latitude/longitude, the provider server 21 sets the content correlation value t to 1 based on the icon type information provision number L of “80” in the case of the icon type “Convenience Store”, and sets the content correlation value t to 0.6 based on the icon type information provision number L of “10” in the case of the icon type “Shop”, and sets the content correlation value t to 0.3 based on the icon type information provision number L of “3” in the case of the icon type “Building”. Also, when there is not the dealer at the arbitrary latitude/longitude (for example, because of an insolvency, a closing business and the like), the dealer at the arbitrary latitude/longitude may be possibly changed (for example, a restaurant is opened after the closing business of the convenience store). Thus, there is no icon type for the arbitrary latitude/longitude. Then, even if the icon type information provision number L is 0, the provider server 21 sets the content correlation value t to 0.1.

The accumulation update content reliability degree y′ is the information to calculate an accumulation update content reliability degree y as the reliability degree indicative of the degree of the reliability of the content (the icon type indicative of the dealer) of the update information, and it is used as a material from which the provider server 21 judges the reliability degree of the update information from the information terminal 1-i on the basis of the reliability degree of that content (the icon type). The accumulation update content reliability degree y′ is correlated to the content correlation value t, the icon type included in the accumulation update content information B, and the icon type information provision number L. This accumulation update content reliability degree y′ is the accumulation update content reliability degree stored by the provider server 21 when the provider server 21 calculates the accumulation update content reliability degree y with regard to the N-th update information. That is, this accumulation update content reliability degree y′ is the accumulation update content reliability degree stored in the update content reliability information database 24 before the provider server 21 calculates the accumulation update content reliability degree y with regard to the (N+1)-th update information.

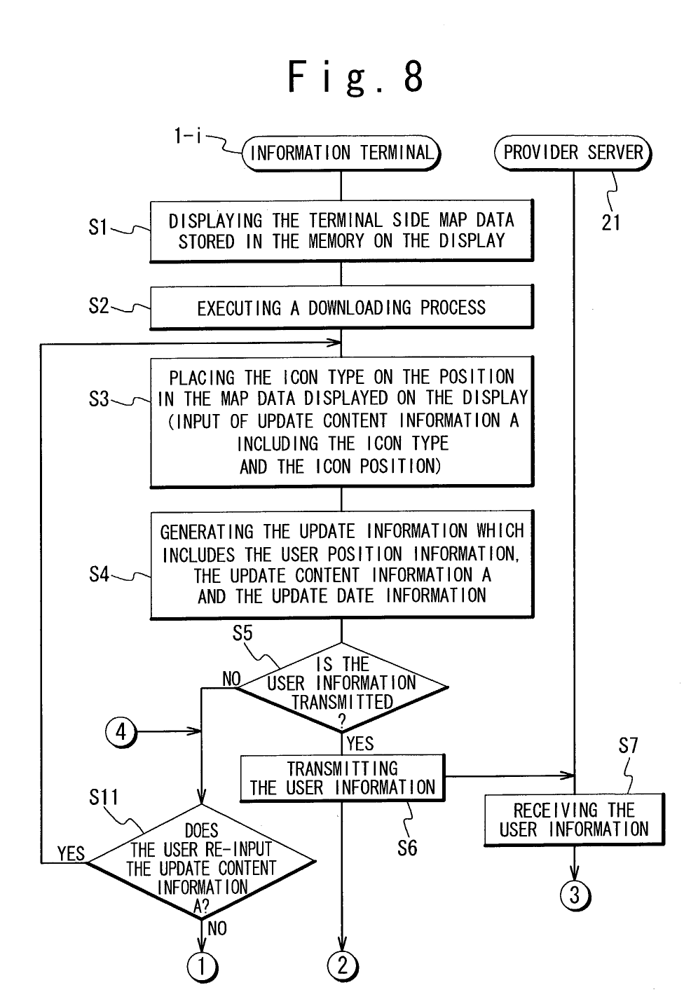

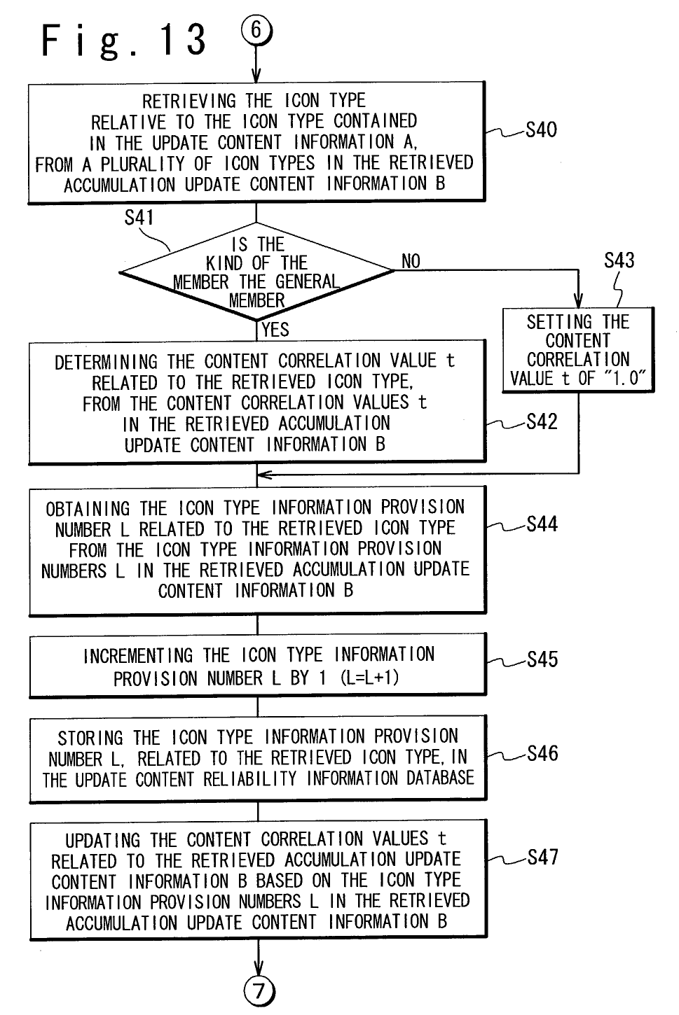

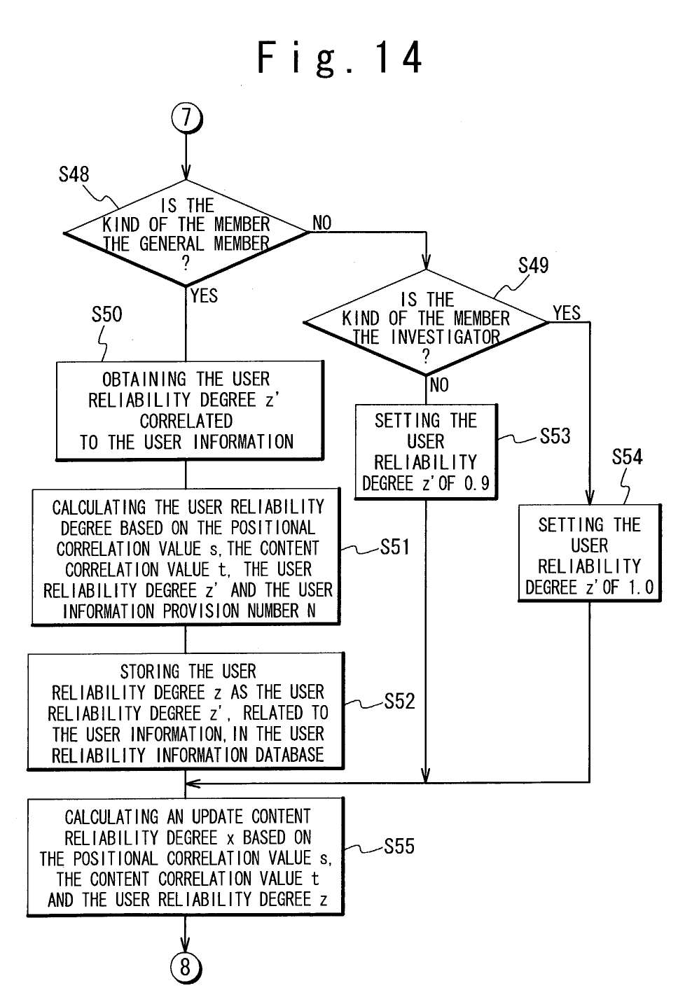

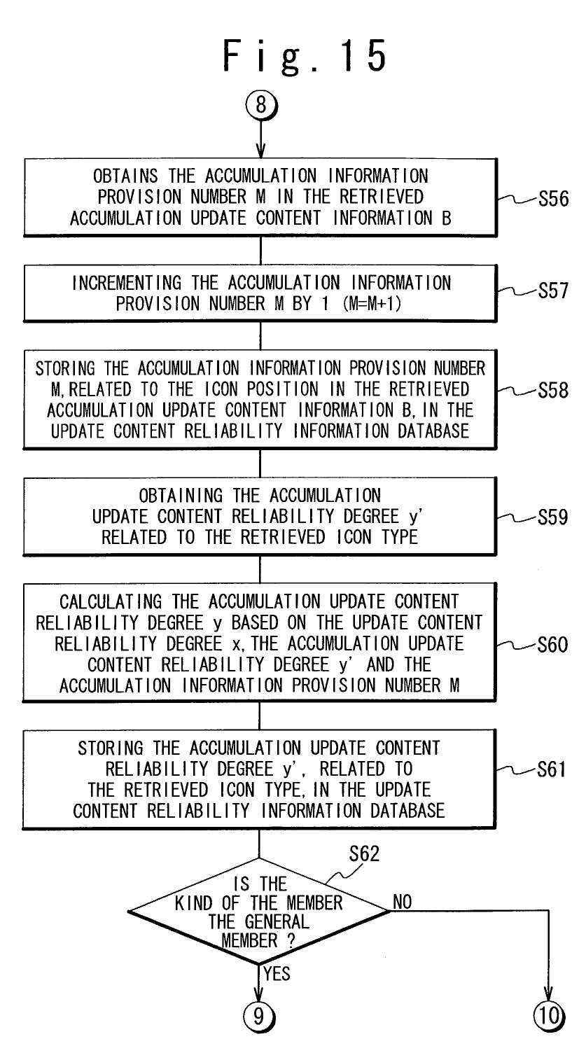

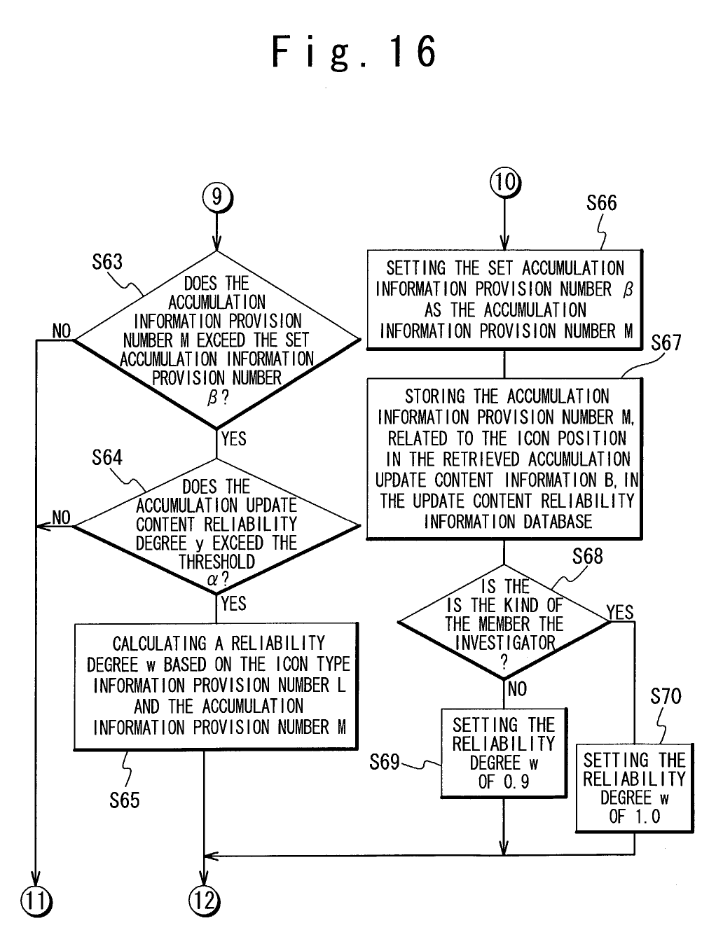

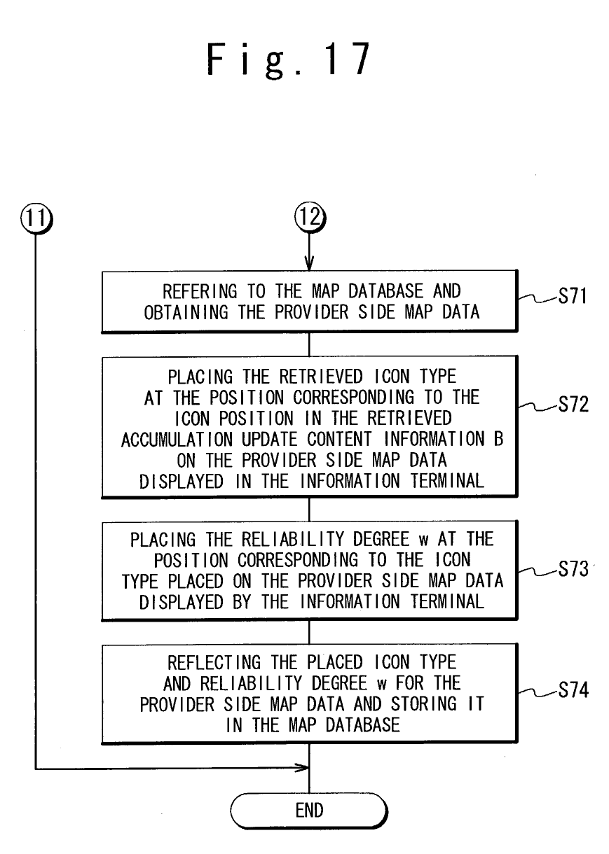

FIGS. 8 to 19 are flowcharts showing the operations of the information providing system and the information providing server The operations of the information providing system includes (1) an operational flow of a map data upload and (2) an operational flow of a map data download.

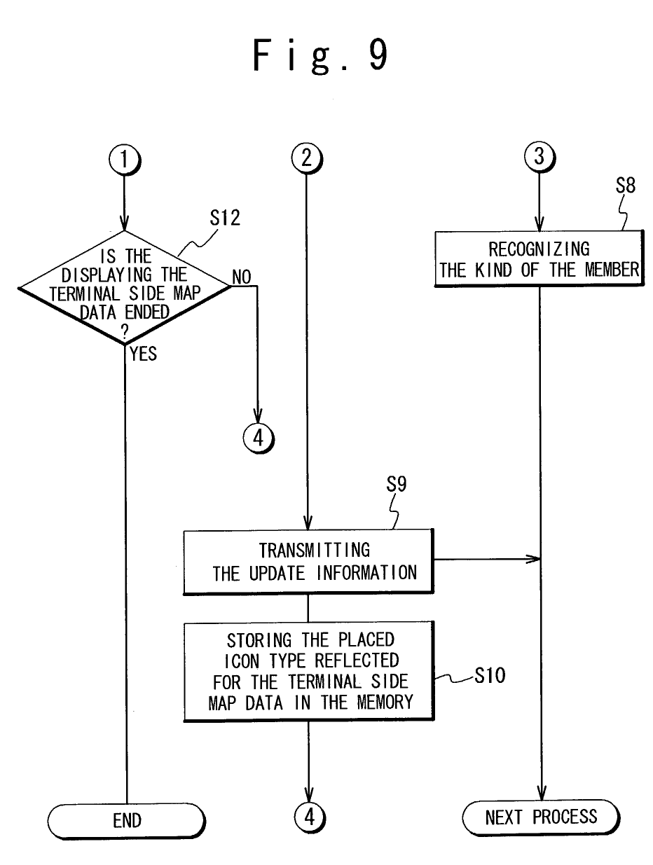

The information terminal 1-i and the provider server 21 execute the (1) operational flow of the map data upload, as shown in FIGS. 8, 9.

At first, the controller 4 of the information terminal 1-i displays on the display 6 the terminal side map data 10 stored in the memory 7, based on the action of the input unit 5 of the user (Step S1). Next, the information terminal 1-i and the provider server 21 execute a downloading process (Steps S82 to S91), which will be described later in the (2) operational flow of the map data download. The controller 4 of the information terminal 1-i downloads the newest terminal side map data 10 provided by the provider server 21 and displays on the display 6 (Step S2). Here, in this embodiment, the step S2 is executed after the execution of the step Si. However, it is not limited thereto. In order to always display the newest terminal side map data 10 on the display 6, the information terminal 1-i may download the newest terminal side map data 10 provided by the provider server 21 and display on the display 6 without displaying the newest terminal side map data 10 stored in the memory 7 on the display 6, after the actuation of the information terminal 1-i. In this case, the information terminal 1-i does not execute the step S1.

Next, the controller 4 inputs the update content information A having the icon type and the icon position (latitude/longitude), by placing the icon type, in such a way that the icon type is displayed at the position on the display 6, which corresponds to the icon position (latitude/longitude) on the map indicated by the terminal side map data 10 displayed on the display 6, based on the action of the input unit 5 of the user (Step S3). At this time, the controller 4 generates the update information, which includes the user position information {the user position (latitude/longitude), the date, and the user ID}, the update content information A and the update date information (Step S4). The update date information indicates the date when the controller 4 generates the update information. The date included in the user position information are used by the provider server 21, as the proof indicating that the user is located at the user position (latitude/longitude) included in the user position information, on the date represented by the update date information when the controller 4 generates the update information, for example, if the information terminal 1-i is connected to and used in an apparatus of an automobile.

Next, the controller 4 monitors the input unit 5 in order to recognize whether or not the user information (the user ID and the password) to access the provider server 21 is transmitted (Step S5). If the user information is transmitted by the action of the input unit 5 of the user (Step S5-YES), the controller 4 outputs the user information (the user ID and the password) to the transmitting/receiving unit 8, and the transmitting/receiving unit 8 transmits the user information to the provider server 21 (Step S6). The provider server 21 receives the user information from the information terminal 1-i (Step S7). The provider server 21 refers to the user reliability information database 25 on the basis of the user information (the user ID and the password) from the information terminal 1-i and thereby recognizes the kind of the member (the general member, the investigator or the special member) correlated to the user information (the user ID and the password) (Step S8).

Next, the controller 4 of the information terminal 1-i accessing the provider server 21 outputs the update information (the user position information, the update content information A and the update date information) to the transmitting/receiving unit 8. The transmitting/receiving unit 8 transmits the update information to the provider server 21 (Step S9). The controller 4 reflects the placed icon type for the terminal side map data 10 and stores in the memory 7 (Step S1). If the user again inputs (re-inputs) the update content information A (Step S11), the information terminal 1-i executes the step S3. Also, if through the action of the input unit 5 of the user, the user does not re-input the update content information A (Step S11-NO) and the terminal side map data 10 is displayed on the display 6 (Step S12-NO), the information terminal 1-i repeatedly executes the steps S11, S12 until the re-input of the update content information A or the end of the indication of the terminal side map data 10. Also, if through the action of the input unit 5 of the user, the user does not re-input the update content information A and ends the indication of the terminal side map data 10 (Step S11-NO, S12-YES), the information terminal 1-i ends the (1) operational flow of the map data download.

On the other hand, if the user information is not transmitted (Step S5 NO) and the update content information A is re-inputted by the action of the input unit of the user (Step S11-YES), the information terminal 1-i executes the step S3. Also, if the user information is not transmitted (Step S5-NO) and the update content information A is not re-inputted by the action of the input unit 5 of the user (Step S11-NO) and the terminal side map data 10 is indicated on the display 6 (Step S12-NO), the information terminal 1-i repeatedly executes the steps S11, S12 until the re-input of the update content information A or the end of the indication of the terminal side map data 10. Also, if the user information is not transmitted (Step S5-NO) and the update content information A is not re-inputted by the action of the input unit 5 of the user and the indication of the terminal side map data 10 is ended (Step S11-NO, S12-YES), the information terminal 1-i ends the (1) operational flow of the map data upload.

When the controller 4 generates the update information having the user position information {the user position (latitude/longitude), the date, and the user ID}, the update content information A and the update date information at the step S4, the information terminal 1-i executes the operational flow of the user position information obtainment. This operational flow of the user position information obtainment designates, for example, the case when the user position information is obtained from the information terminal 1-i having the terminal side GPS 9. If the user position information is obtained from the information terminal 1-i that does not have the terminal side GPS 9 (for example, the information terminal 1-i such as PHS), the provider server 21 executes the operational flow of the user position information obtainment at a step S31 as described later. In this case, at the step S4, the controller 4 generates the update information having the update content information A and the update date information, except the user position information {the user position (latitude/longitude), the date, and the user ID}.

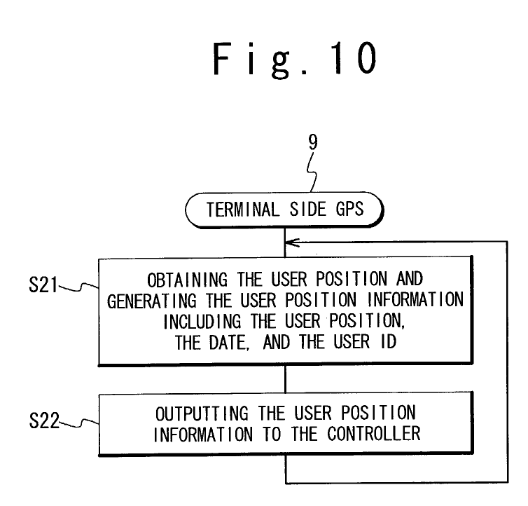

The operational flow of the user position information obtainment executed by the information terminal 1-i (the information terminal 1-i having the terminal side GPS 9) will be described below with reference to FIG. 10. As shown in FIG. 10, the terminal side GPS 9 obtains the latitude/longitude indicative of the position of the information terminal 1-i as the user position (corresponding to the user position 15) and generates the user position information including the user position (latitude/longitude), the date, and the user ID stored in the memory 7 (Step S21). The terminal side GPS 9 outputs the user position information to the controller 4 (Step S22) and executes the step S21.

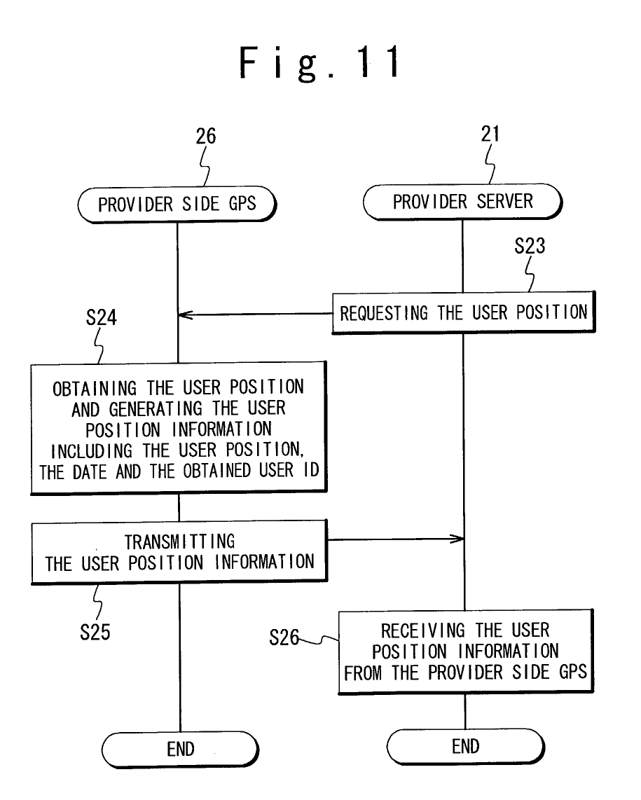

The operational flow of the user position information obtainment executed by the provider server 21 will be described below with reference to FIG. 11. As shown in FIG. 11, the provider server 21, when receiving the update information from the information terminal 1-i, performs the user position request of the information terminal 1-i on the provider side GPS 26 (Step S23). The provider side GPS 26 obtains the user ID from the information terminal 1-i through an electric wave, based on the user position request from the provider server 21 (the information terminal 1-i transmits to the provider side GPS 26 the user ID stored in the memory 7, based on the electric wave from the provider side GPS 26). The provider side GPS 26 obtains the latitude/longitude indicative of the position of the information terminal 1-i as the user position (corresponding to the user position 15) and generates the user position information having the user position (latitude/longitude), the date and the obtained user ID (Step S24). The provider side GPS 26 transmits this user position information to the provider server 21 (Step S25). The provider server 21 receives the user position information from the provider side GPS 26 and obtains the update information including the user position information {the user position (latitude/longitude), the date and the user ID)}, the update content information A and the update date information (Step S26).

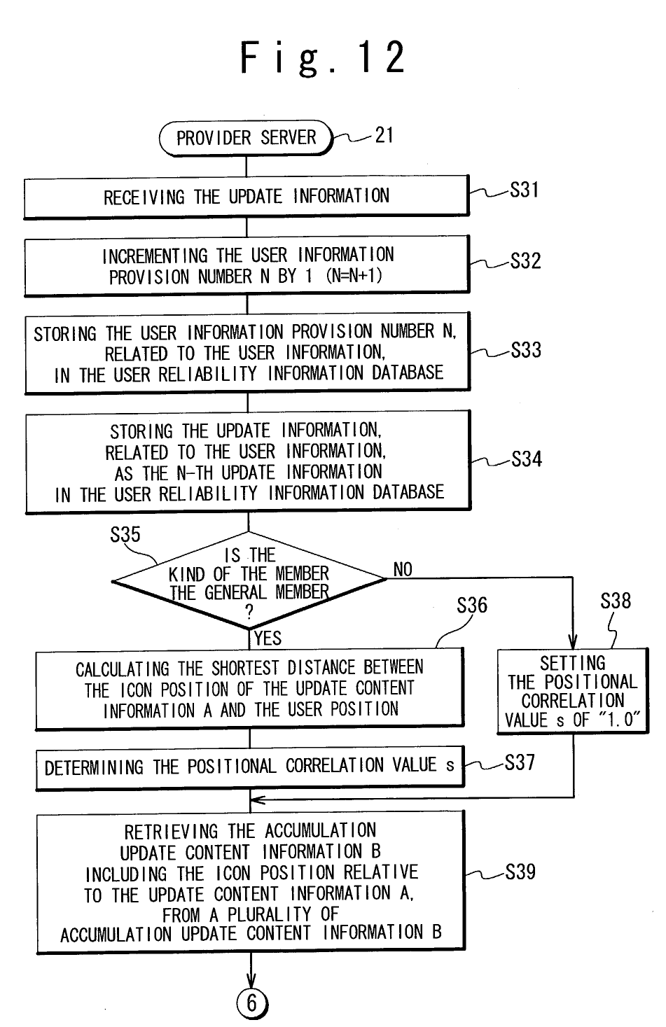

Next, the provider server 21 executes (continues) the (1) operational flow of the map data upload, as shown in FIGS. 12 to 17, after the execution of the step S8.

At first, the provider server 21 receives the update information (the user position information, the update content information A and the update date information) transmitted from the information terminal 1-i at the step S9 (Step S31). Here, if the update information does not contain the user position information, the provider server 21 performs the user position request (executes the operational flow of the user position information obtainment) and obtains the update information having the user position information {the user position (latitude/longitude), the date and the user ID)}, the update content information A and the update date information. The provider server 21 refers to the user reliability information database 25 and increments the user information provision number N by 1 (N=N+1) (Step S32). At this time, due to N=N+1, the user information provision number N is incremented by 1. The provider server 21 correlates the user information provision number N incremented by 1, to the user information (the user ID and the password) recognized at the step S8, and stores in the user reliability information database 25 (Step S33). The provider server 21 correlates the update information (the user position information, the update content information A and the update date information) received at the step S31, to the user information recognized at the step S8, and stores it as the N-th update information in the user reliability information database 25 (Step S34).

Next, as the result of the recognition of the user information at the step S8, if the kind of the member is the general member (Step S35-YES), the provider server 21 automatically calculates the shortest distance between the icon position (latitude/longitude) included in the update content information A and the user position (latitude/longitude) indicated by the user position information (Step S36). The provider server 21 refers to the positional correlation value database 23 and determines the positional correlation value s correlated to the calculated distance (Step S37). For example, if the calculated distance is 15 [m], at the step S37, the provider server 21 refers to the positional correlation value database 23 and determines the positional correlation value s of “0.9” correlated to the calculated distance range “11 to 20”.

Next, the provider server 21 refers to the update content reliability information database 24 and retrieves the accumulation update content information B having the icon position (latitude/longitude) relative to the icon position (latitude/longitude) contained in the update content information A, from a plurality of accumulation update content information B (Step S39). The provider server 21 refers to the update content reliability information database 24 and retrieves the icon type relative (similar) to the icon type contained in the update content information A, from a plurality of icon types contained in the retrieved accumulation update content information B (Step S40). For example, if the icon type contained in the update content information A represents “Convenience Store”, at the step S40, the provider server 21 retrieves the icon type indicative of “Convenience Store” similar to the icon type contained in the update content information A, from the plurality of icon types contained in the retrieved accumulation update content information B. In this case, the icon type contained in the update content information A is the same kind as the retrieved icon type.

Next, if the kind of the member is the general member (Step S41-YES), the provider server 21 refers to the update content reliability information database 24, as the result retrieved at the step S40, and thereby determines the content correlation value t (similarity t) correlated to the retrieved icon type (the similar icon type), from a plurality of content correlation values t contained in the retrieved accumulation update content information B (Step S42). In this case, at the step S42, the provider server 21 refers to the update content reliability information database 24 and thereby determines the content correlation value t of “1.0” correlated to the retrieved icon type “Convenience Store”, from the plurality of content correlation values t contained in the retrieved accumulation update content information B.

Next, the provider server 21 refers to the update content reliability information database 24 and obtains the icon type information provision number L of “80” correlated to the retrieved icon type “Convenience Store” from the plurality of icon type information provision numbers L contained in the retrieved accumulation update content information B (Step S44). The provider server 21 increments the obtained icon type information provision numbers L of “80” by 1 (Step S45). At this time, the icon type information provision number L of “80” is incremented through L=L+1. The provider server 21 correlates the icon type information provision number L of “80”, which is incremented by 1, to the retrieved icon type “Convenience Store”, and stores in the update content reliability information database 24 (Step S46). The provider server 21 refers to the update content reliability information database 24 and updates the plurality of content correlation values t correlated to the retrieved accumulation update content information B based on the plurality of icon type information provision numbers L of “81”, “10”, “3”, . . . , “0” contained in the retrieved accumulation update content information B (Step S47).

Next, if the kind of the member is the general member (Step S48-YES), the provider server 21 refers to the user reliability information database 25 and obtains the user reliability degree z′ correlated to the user information recognized at the step S8 (Step S50). The provider server 21 automatically calculates the user reliability degree z indicative of the reliability degree of the user, based on the positional correlation value s, the content correlation value t, the user reliability degree z′ and the user information provision number N (Step S51). The user reliability degree z is calculated by using an equation of z={(s×t)+z′×(N−1)}/N. The provider server 21 uses the user reliability degree z as the user reliability degree z′, and correlates to the user information recognized at the step S8, and then stores in the user reliability information database 25 (Step S52).

Next, the provider server 21 automatically calculates an update content reliability degree x indicative of the reliability degree of the content (icon type) of the update information from the information terminal 1-i based on the positional correlation value s, the content correlation value t and the user reliability degree z (Step S55). The update content reliability degree x is calculated by using an equation of x=s×t×z. The provider server 21 refers to the update content reliability information database 24 and obtains the accumulation information provision number M contained in the retrieved accumulation update content information B (Step S56). The provider server 21 increments the accumulation information provision number M by 1 (Step S57). At this time, the accumulation information provision number M is incremented through M=M+1. The provider server 21 correlates the accumulation information provision number M, which is incremented by 1, to the icon position (latitude/longitude) contained in the retrieved accumulation update content information B, and stores in the update content reliability information database 24 (Step S58).

Next, the provider server 21 refers to the update content reliability information database 24 and obtains the accumulation update content reliability degree y′ correlated to the retrieved icon type “Convenience Store” (Step S59). The provider server 21 automatically calculates the accumulation update content reliability degree y indicative of the accumulation value of the reliability degree of the content (icon type) of the update information, based on the update content reliability degree x, the accumulation update content reliability degree y′ and the accumulation information provision number M (Step S60). The accumulation update content reliability degree y is calculated by using an equation of y=x+y′×M. Here, the update content reliability degree x is calculated by the equation of x=s×t×z. Thus, the provider server 21 can reflect for the user reliability degree history z′ (the user reliability degree z) and calculate the accumulation update content reliability degree y. The provider server 21 uses the accumulation update content reliability degree y as the accumulation update content reliability degree y′, and correlates to the retrieved icon type “Convenience Store” and then stores in the update content reliability information database 24 (Step S61). Here, in this embodiment, if the kind of the member is the general member, at the step S60, the provider server 21 calculates the accumulation update content reliability degree y based on the positional correlation value s determined on the basis of the calculated distance (the shortest distance). However, this is not limited thereto. At the step S60, the provider server 21 can calculate the accumulation update content reliability degree y based on the geographical situation indicating whether or not it can be moved to the indication position {the icon position (latitude/longitude)} from the user position (latitude/longitude) at the shortest distance. In this case, at first, the provider server 21 automatically calculates the accumulation update content reliability degree y based on the update content reliability degree x, the accumulation update content reliability degree y′ and the accumulation information provision number M, and further refers to the map database 22, and then judges whether or not it can be moved to the indication position {the icon position (latitude/longitude)} from the user position (latitude/longitude) at the shortest distance based on the geographical situation, and automatically calculates (determines) the final accumulation update content reliability degree y based on the judged result. As the final accumulation update content reliability degree y (the determined accumulation update content reliability degree y), for example, if there is a building between the user position (latitude/longitude) and the indication position {the icon position (latitude/longitude)} on the map indicated by the provider side map data 20 stored in the map database 22, the provider server 21 subtracts a preset value (for example, 0.1) from the calculated accumulation update content reliability degree y.

Next, if the kind of the member is the general member (Step S62-YES), the provider server 21 compares the accumulation information provision number M with a set accumulation information provision number â (for example, â=100) (Step S63). Here, in this embodiment, the set accumulation information provision number â is assumed to be 100. However, this is not limited thereto. The provider server 21 sets in advance a set reliability degree (threshold á) with respect to the accumulation update content reliability degree y to update the provider side map data 20, on the basis of the action of the provider. If the accumulation information provision number M exceeds the set accumulation information provision number â (Step S63-YES), the provider server 21 compares the accumulation update content reliability degree y with the preset threshold á (for example, á=0.8) (Step S64). Here, in this embodiment, the threshold á is assumed to be 0.8. However, this is not limited thereto. If the accumulation update content reliability degree y exceeds the threshold á (Step S64-YES), the provider server 21 automatically calculates a reliability degree w as the update reliability degree indicative of the degree of the reliability of the updated map data, based on the icon type information provision number L and the accumulation information provision number M (Step S65). The reliability degree w is calculated by using an equation of w=L/M×100. In this case, the reliability degree w designates the degree of the existence of the dealer “Convenience Store”.

Next, the provider server 21 refers to the map database 22 and obtains the provider side map data 20 (Step S71). The provider server 21 places the retrieved icon type at the position corresponding to the icon position (latitude/longitude) contained in the retrieved accumulation update content information B on the map indicated by the provider side map data 20 so that the retrieved icon type is displayed by the information terminal 1-i (Step S72). The provider server 21 places the reliability degree w at the position corresponding to the icon type placed on the map indicated by the provider side map data 20 so that the reliability degree w is displayed by the information terminal 1-i (Step S73). The provider server 21 reflects the placed icon type and reliability degree w for the provider side map data 20, and stores in the map database 22 (Step S74) and then ends the (1) operational flow of the map data upload.

On the other hand, if the accumulation information provision number M does not exceed the set accumulation information provision number â (Step S63-NO) and the accumulation update content reliability degree y does not exceed the threshold á (Step S64-NO), the provider server 21 ends the (1) operational flow of the map data upload.

Also, as the result of the recognition of the user information at the step S8, if the kind of the member is not the general member (Step S35-NO), the user is the special member trusted by the provider or the investigator. Thus, the provider server 21 sets the positional correlation value s, for example, to “1” (Step S38) and executes the step S39 without executing the steps S36, S37. In this embodiment, if the kind of the member is the special member or the investigator, the positional correlation value s is set to “1”. However, this is not limited thereto. The positional correlation value s may be represented by any numeral in the range between 0 and 1. Similarly to the general member, the provider server 21 may execute the steps S36, S37.

Also, if the kind of the member is not the general member (Step S41-NO), the provider server 21 sets the content correlation value t, for example, to “1” (Step S43) and executes the step S44 without executing the step S42. In this embodiment, if the kind of the member is the special member or the investigator, the content correlation value t is set to “1”. However, this is not limited thereto. The content correlation value t may be represented by any numeral in the range between 0 and 1. Similarly to the general member, the provider server 21 may execute the step S41.

Also, if the kind of the member is the special member (Step S48-NO, S49-NO), the provider server 21 sets the user reliability degree z′, for example, to “0.9” (Step S53) and executes the step S55 without executing the steps S50 to S52. If the kind of the member is the investigator (Step S48-NO, S49-YES), the provider server 21 sets the user reliability degree z′, for example, to “1” (Step S54) and executes the step S55 without executing the steps S50 to S52. In this embodiment, if the kind of the member is the special member or the investigator, the user reliability degree z′ is set to “0.9” or “1” However, this is not limited thereto. The user reliability degree z′ may be represented by using any numeral in the range between 0 and 1. Or, similarly to the general member, the provider server 21 may execute the steps S51 to S52.

Also, if the kind of the member is not the general member (Step S62-NO), the provider server 21 does not execute the steps S63 to S65. In this case, the user is the special member trusted by the provider or the investigator. Thus, the provider server 21 uses the set accumulation information provision number a as the accumulation information provision number M (Step S66) and deletes the standard to judge whether or not the accumulation information provision number M exceeds the set accumulation information provision number â. The provider server 21 correlates the accumulation information provision number M to the icon position (latitude/longitude) contained in the retrieved accumulation update content information B and stores in the update content reliability information database 24 (Step S67). If the kind of the member is the special member (Step S68-NO), the provider server 21 sets the reliability degree w, for example, to “0.9” (Step S69) and executes the step S71. If the kind of the member is the investigator (Step S68 YES), the provider server 21 sets the reliability degree w, for example, to “1” (Step S70) and executes the step S71. In this embodiment, if the kind of the member is the special member or the investigator, the reliability degree w is set to “0.9” or “1”. However, this is not limited thereto. The reliability degree w may be represented by using any numeral in the range between 0 and 1. In this case, in the special member, for example, in the range between “Shop” such as a personal shop and “Building” such as a big company, the reliability degree w is set to “0.9” to “1”, and a step-by-step rank may be established.

Also, at the step S74, the provider server 21 reflects the placed icon type and reliability degree w for the provider side map data 20 and stores in the map database 22, and then transmits the update report indicative of the update of the provision information to the information terminal 1-i of the user related to the update information (including the above-mentioned user).

Here, the related user is the user located at the icon position (latitude/longitude) contained in the update content information A of the update information or in the vicinity of the icon position (latitude/longitude). The user located in the vicinity of the icon position (latitude/longitude) is exemplified as the user located at the set region with the icon position (latitude/longitude) as the center In this case, the provider server 21 performs the user position request on the provider side GPS 26, in order to transmit the update report to the information terminal 1-i of the related user located at the icon position (latitude/longitude) or in the vicinity thereof. At the step S23, the provider server 21 performs the user position requests of the information terminals 1-1, 1-2 to 1-n on the provider side GPS 26. At the step S24, the provider side GPS 26 generates the user position information {the user position information similar to the above-mentioned case, which has the user position (latitude/longitude) and the user ID} of the information terminals 1-1, 1-2 to 1-n, in response to the user position request from the provider server 21. At the step S25, the provider side GPS 26 transmits the N user position information to the provider server 21. At the step S26, the provider server 21 receives the N user position information from the provider side GPS 26. At the step S74, the provider server 21 retrieves the user position icon position having the user position (latitude/longitude) relative to the icon position (latitude/longitude) or the vicinity thereof, from the N user position information, and then recognizes the user ID contained in the retrieved user position information as the user ID of the above-mentioned related user. Consequently, at the step S74, the provider server 21 can refer to the user reliability information database 25 to thereby transmit the update report to the information terminal 1-i of the related user, based on the user ID of the related user. According to the information providing system of the present invention, the fact of the update of the provision information (the provider side map data 20) is reported to the user (the related user). Hence, the convenience is improved.

Also, the related user is the user who previously transmitted the update content information A (update information) having the icon position (latitude/longitude) and the user information (the user ID and the password) to the provider server 21. In this case, the provider server 21 stores the user information (the user ID and the password) in the update content reliability information database 24 by correlating to (the retrieved accumulation update content information B having) the icon type similar to the icon type contained in the update content information A and the accumulation update content reliability degree y′, at the steps S31 to S61. Consequently, when the similar icon type (the provider side map data 20) is updated at the steps S62 to S74, the provider server 21 can refer to the update content reliability information database 24 at the step S74 and thereby transmit the update report to the information terminal 1-i of the related user, based on the user information (the user ID) of the related user. According to the information providing system of the present invention, the fact of the update of the provision information (the provider side map data 20) is reported to the user (the related user). Hence, the convenience is improved.

Also, the related user is the user who preliminarily transmits to the provider server 21 the reception request indicating that the user receives the update report with regard to the similar icon type through the information terminal 1-i. In this case, when the related user carries out the reception request in advance, the provider server 21 stores the reception request in the user reliability information database 25 by correlating to the user information (the user ID and the password) of the related user, at the steps S31 to S61. Consequently, when the similar icon type (the provider side map data 20) is updated at the steps S62 to S74, the provider server 21 can refer to the user reliability information database 25 at the step S74 and thereby transmit the update report to the information terminal 1-i of the related user, based on the user information (the user ID) of the related user. According to the information providing system of the present invention, the fact of the update of the provision information (the provider side map data 20) is reported to the user (the related user). Hence, the convenience is improved.

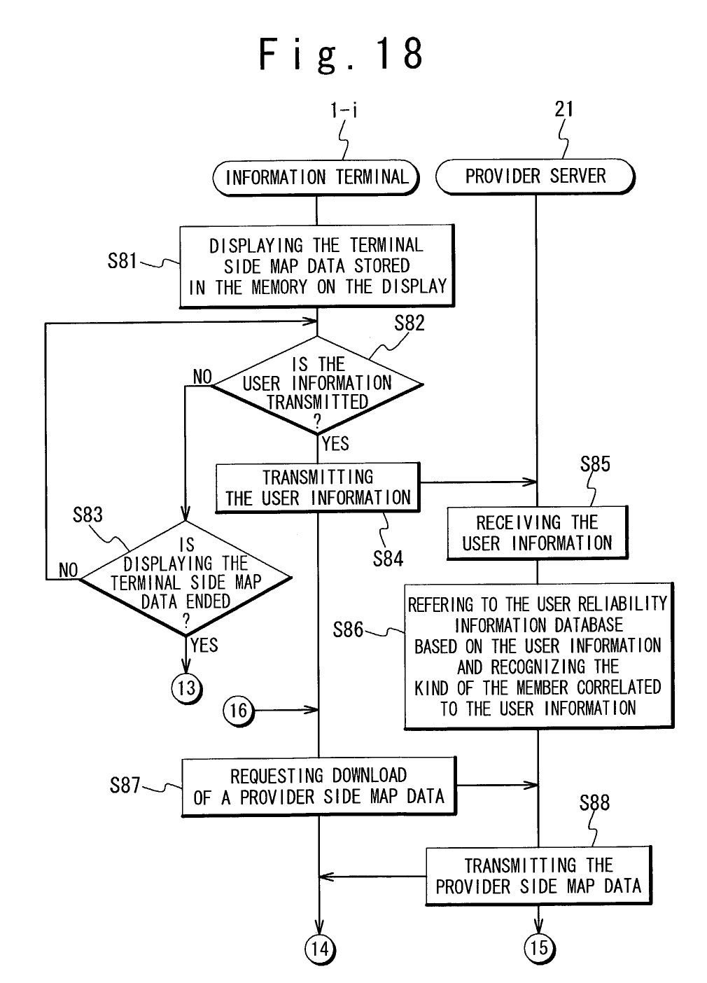

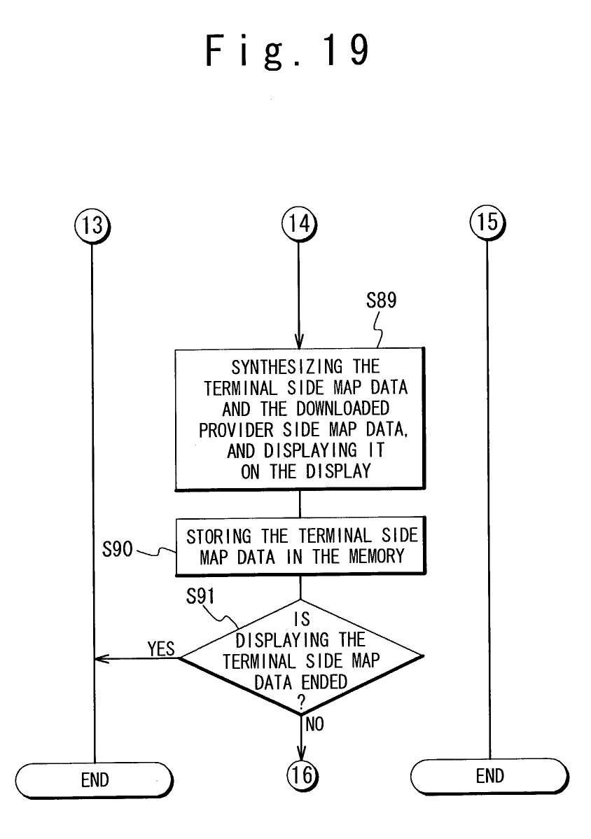

Next, the information terminal 1-i (or the information terminal 1-i receiving the update report) and the provider server 21 execute the (2) operational flow of the map data download, as shown in FIGS. 18, 19.

At first, the controller 4 of the information terminal 1-i displays the terminal side map data 10 stored in the memory 7 on the display 6 on the basis of the action of the input unit 5 of the user (Step S81). The controller 4 monitors the input unit 5 in order to recognize whether or not the user information (the user ID and the password) to access the provider server 21 is transmitted (Step S82). If the user information is not transmitted (Step S82-NO), and the terminal side map data 10 is displayed on the display 6 (Step S83-NO), the information terminal 1-i repeatedly executes the steps S82, S83 until the transmission of the user information or the end of the display of the terminal side map data 10.

If the user information is transmitted on the basis of the action of the input unit 5 of the user (Step S82-YES), the controller 4 outputs the user information (the user ID and the password) to the transmitting/receiving unit 8, and the transmitting/receiving unit 8 transmits the user information to the provider server 21 (Step S84). The provider server 21 receives the user information from the information terminal 1-i (Step S85). The provider server 21 refers to the user reliability information database 25 based on the user information (the user ID and the password) from the information terminal 1-i and recognizes the kind of the member (the general member, the investigator or the special member) correlated to the user information (the user ID and the password) (Step S86).

Next, the controller 4 of the information terminal 1-i accessing the provider server 21 outputs a provider side map data request to the transmitting/receiving unit 8, in order to require the provider server 21 to download the provider side map data 20, and the transmitting/receiving unit 8 transmits the provider side map data request to the provider server 21 (Step S87). The provider server 21 transmits the provider side map data 20 stored in the map database 22 to the information terminal 1-i, in response to the provider side map data request (Step S88). At this time, the information terminal 1-i receives (downloads) the provider side map data 20. Also, at the step S88, the provider server 21 refers to the update content reliability information database 24 and the user reliability information database 25 in response to the provider side map data request and transmits the provider side map data 20 stored in the map database 22 to the information terminal 1-i of the abovementioned related user.

The controller 4 of the information terminal 1-i synthesizes the terminal side map data 10 and the downloaded provider side map data 20 and displays on the display 6. The controller 4 stores (updates) the terminal side map data 10, in which the provider side map data 20 is synthesized, in the memory 7 (Step S90). If the terminal side map data 10 is displayed on the display 6 (Step S91-NO), the information terminal 1-i executes the step S87. If the display of the terminal side map data 10 is ended (Step S91-YES), the information terminal 1-i ends the (2) operational flow of the map data download.

In this way, the provider server 21 can transmit to the information terminal 1-i the provider side map data 20 updated at the steps S85, S86 and S88 and provide to the user (the related user).

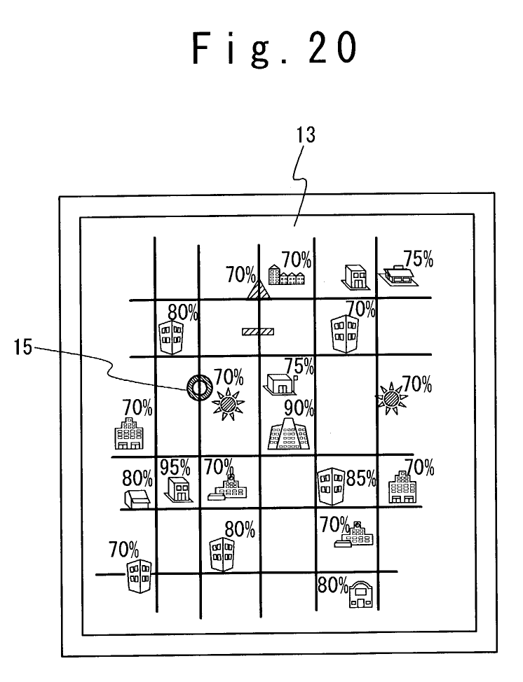

The icon type and the reliability degree w reflected in the provider side map data 20 at the steps S72 to S74 are displayed on the display 6 of the information terminal 1-i at the step S89 as shown in FIG. 20, since the updated provider side map data 20 is transmitted by the provider server 21 at the step S88. That is, the updated provider side map data 20 is displayed as the plurality of icons (icon types) on the display 6 of the information terminal 1-i at the step S89, and the reliability degree w is displayed on the display 6 of the information terminal 1-i as the numeral and the character (percentage) correlated to each of the plurality of icons. In this case, the reliability degree w is placed at the position corresponding to the icon type (the icon that is the business information indicative of the business carried out by the dealer) placed on the map indicated by the provider side map data 20, and it indicates (is represented as) the degree of the dealer existence at a percentage (%). As the percentage is higher, the existence of the dealer is higher. Here, if the reliability degree w set at the steps S69, S70 is “1”, namely, “100%”, it is not necessary to indicate the “100%” as the determined information (icon type). The above-mentioned provider side map data 20 is downloaded by the information terminal 1-i, and synthesized with the terminal side map data 10 and displayed at the step S89.

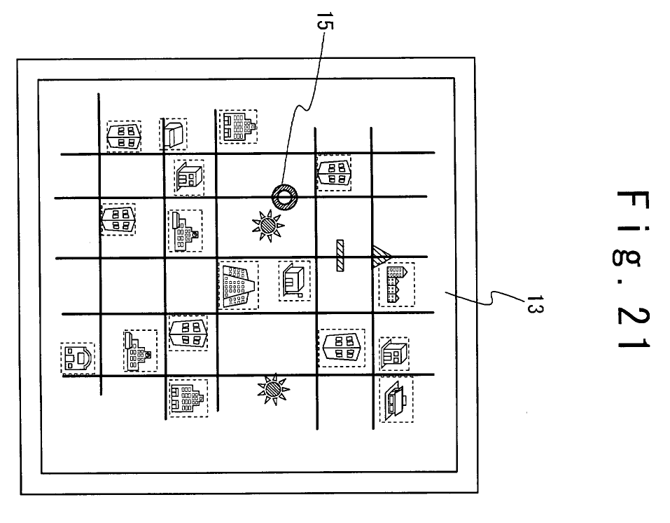

Also, the icon type and the reliability degree w reflected in the provider side map data 20 at the steps S72 to S74 are displayed on the display 6 of the information terminal 1-i at the step S89 as shown in FIG. 21, since the updated provider side map data 20 is transmitted by the provider server 21 at the step S88. That is, the updated provider side map data 20 is displayed as the plurality of icons (icon types) on the display 6 of the information terminal 1-i at the step S89, and the reliability degree w is displayed on the display 6 of the information terminal 1-i, by using the icon (for example, the icon type “Convenience Store”) corresponding to the update information from the plurality of icons (icon types) or the difference in the color between the corresponding icon type “Convenience Store” and the icon types except the corresponding icon type “Convenience Store” among the plurality of icon types. In this case, the reliability degree w is placed at the icon type (the icon implying the business information indicative of the business carried out by the dealer) placed on the map indicated by the provider side map data 20, and it represents (it is represented as) the icon type through the kind of the color as the degree of the dealer existence. For example, the degree of the dealer existence is decreased in the color order of red, blue, yellow, . . . . Or, in this case, the reliability degree w is placed at the icon type (the icon implying the business information indicative of the business carried out by the dealer) placed on the map indicated by the provider side map data 20, and it represents (it is represented as) the icon type through the concentration of the color as the degree of the dealer existence. For example, the degree of the dealer existence is higher as the concentration of the color is higher. The above-mentioned provider side map data 20 is downloaded by the information terminal 1-i, and it is synthesized with the terminal side map data 10 and displayed at the step S89.

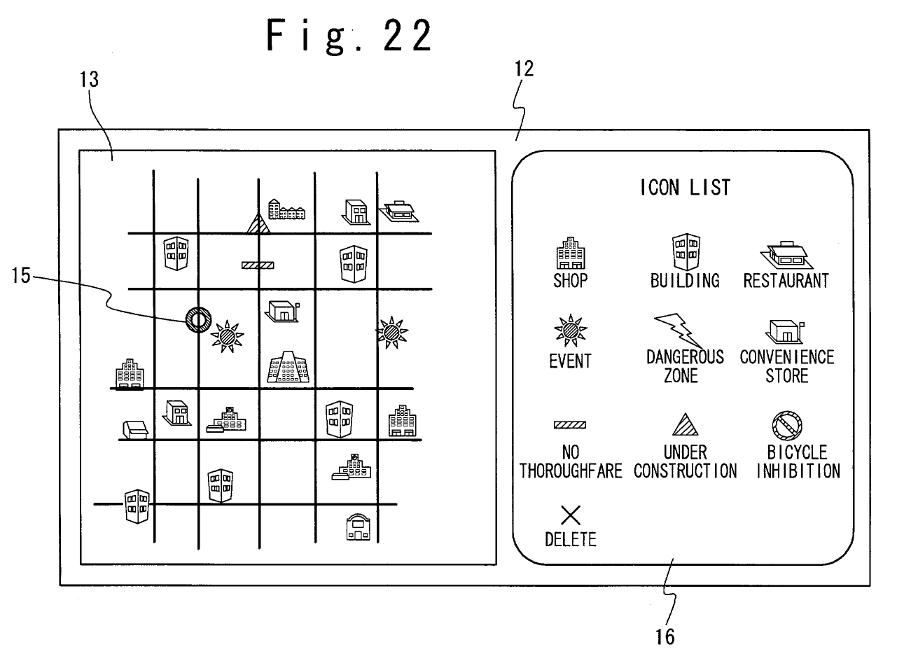

By the way, in this embodiment, the portable telephone is exemplified as the information terminal 1-i (portable terminal) having the position sensor (terminal side GPS) 9. However, this is not limited thereto. PDA and a note type PC are exemplified. In this case, a screen 12 displayed on a display 5 includes: a screen 13 where the terminal side map data 10 is displayed on the display 5 as shown in FIG. 22; and a screen 16 where the icon type is displayed on the display 5 as an icon list. On the screen 16, the icon list illustrated on the above-mentioned screen 14 does not include the icon number to identify the icon, and it includes the above-mentioned icon and the icon notification to inform the user of the icon through the character.

For example, let us suppose that an event is discovered inside or outside a house near the user when the user is moving. The user operates the input unit 5 of the information terminal 1-i (PDA or a note type PC), and the controller 4 of the information terminal 1-i displays the screen 12 (the screens 13, 16) on the display 6, in response to the action of the input unit 5 of the user. If the icon indicative of “Event” does not exist near the user position 15 on the map indicated by the terminal side map data 10 on the screen 13, the user can place the icon type (the icon “Event”) at the corresponding position near the user position 15 by using the information terminal 1-i.

In this case, the user operates the input unit 5 (mouth) of the information terminal 1-i and clicks and selects the icon indicative of “Event” on the screen 16. The icon “Event” is selected when the user uses the input unit 5 (mouth) and clicks the icon indicative of “Event” on the screen 16. The user operates the input unit 5 (mouth) of the information terminal 1-i. Then, the user moves and places the selected icon “Event” at the corresponding position near the user position 15 on the map so that the selected icon “Event” is placed near the user position 15 on the map indicated by the terminal side map data 10 on the screen 13. At this time, the controller 4 places the icon “Event” at the corresponding position near the user position 15 on the map indicated by the terminal side map data 10. The icon “Event” is moved and placed when the user uses the input unit 5 (mouth) and again clicks the selected icon “Event” and then drops it in the vicinity of the user position 15 on the map indicated by the terminal side map data 10.

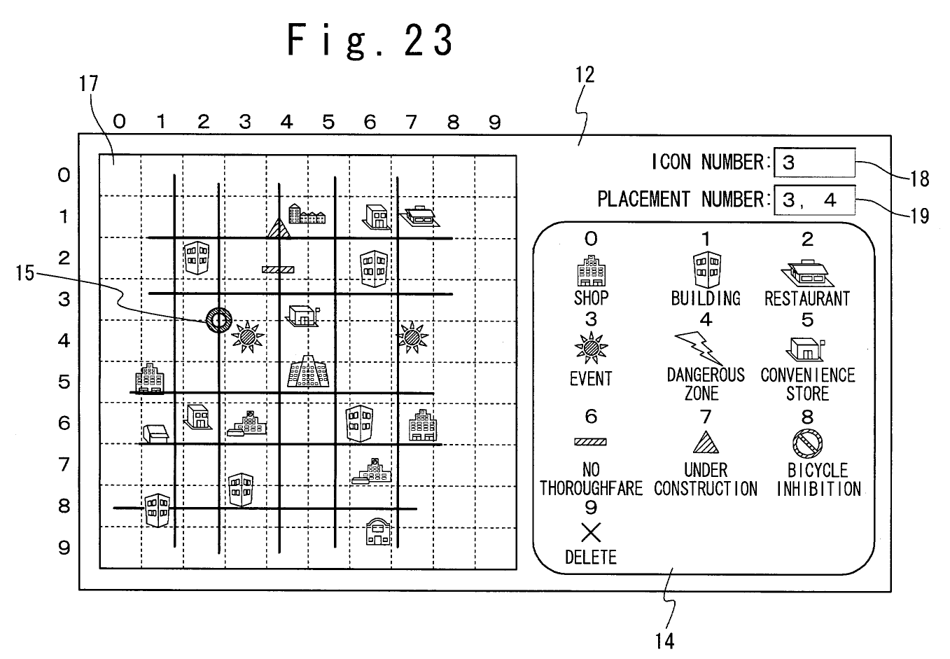

Also, if the information terminal 1-i (portable terminal) having the position sensor 9 is the portable telephone, as shown in FIG. 23, the screen 12 displayed on the display 5 includes; a screen 17 where the terminal side map data 10 is displayed on the display 5; a screen 14 where the icon type is displayed on the display 5 as the icon list (the icon, the icon number and the icon notification); a screen 18 to which the icon number is inputted; and a screen 19 to which a placement number is inputted. On the screen 17, the above-mentioned screen 17 is illustrated in the shape of measures (for example, lateral nine measures and longitudinal nine measures). If the element composed of the lateral nine measures and the longitudinal nine measures is assumed to be a standard placement number “0, 0” the respective components of the element are represented as the replacement numbers “0, 0” to “9, 9”. This placement number corresponds to the latitude/longitude as the icon position.

For example, let us suppose that an event is discovered inside or outside a house near the user when the user is moving. The user operates the input unit 5 of the information terminal 1-i (portable telephone), and the controller 4 of the information terminal 1-i displays the screen 12 (the screens 17, 14, 18 and 19) on the display 6, in response to the action of the input unit 5 of the user. If the icon indicative of “Event” does not exist near the user position 15 on the map indicated by the terminal side map data 10 on the screen 17, the user can place the icon type (the icon “Event”) at the corresponding position near the user position 15 by using the information terminal 1-i.

In this case, the user operates the input unit 5 of the information terminal 1-i and inputs to the screen 18 the icon number “3” contained in the icon type on the screen 14. The user operates the input unit 5 of the information terminal 1-i. Then, the user inputs the placement number “3, 4” (the lateral “3” and the longitudinal “4” indicative of the placement number) to the screen 19 so that the icon “Event” is placed near the user position 15 on the map indicated by the terminal side map data 10 on the screen 17. The user operates the input unit 5 (pushes down the determination key of the portable telephone). Consequently, the controller 4 places the icon “Event” at the corresponding position (the placement number “3, 4”) near the user position 15 on the map indicated by the terminal side map data 10.

According to the information providing system of the present invention, when the large number of uncertain users provide the update information to update the provision information (map data) to the provider, it can automatically calculate the reliability degree indicative of the degree of the reliability of the update information so that the map data (provider side map data) possessed by the provider can be updated so as to be reflected in the update information. Thus, the reliable provision information (map data) can be provided. Here, as the merit of providing the update information, the map data download is free of charge, and the cash-back of a communication fee is carried out to further improve the usability of the information providing system of the present invention.

According to the information providing system of the present invention, the large number of users update the map data. Thus, it is possible to establish the map database 22 in which the newest map data is always stored. Consequently, the provider can always grasp and manage the actual situation of the map that is changed in the real time. Also, since the newest map data is provided to the user, the user can always grasp the newest map data.

According to the information providing system of the present invention, the user provides to the provider the update information as the newest information. Thus, the providing dealer (provider) managing the map data can reduce the number of the investigators and thereby expect the drop in the cost.

According to the information providing system of the present invention, the user who is the special member (the user carrying out the business in the scale from “Shop” such as the personal shop to “Building” such as the big company) provides the update information as the newest information to the provider. Thus, the update information can be reported as the propagation to the user who is the general member. Hence, the advertisement income can be expected from the propagation.

According to the information providing system of the present invention, the large number of users update the map data. Thus, it has a community element. Hence, it can be used as a location (site) where the information can be shared between the users.

What is claimed is:

1. An information providing system comprising:
an information terminal which belongs to a user; and
a providing server which is connected to said information terminal through a network;
wherein said providing server transmits provision information from said providing server to said information terminal through said network, when receiving an update information which is for updating said provision information and includes relation information related to said user from said information terminal, said providing server calculates an information reliability degree indicating a degree of a reliability of said update information based on at least one of said relation information and said update information, and
said providing server updates said provision information based on said information reliability degree and said update information.

2. The information providing system according to claim 1, wherein said provision information is map information related to a map.

3. The information providing system according to claim 2, wherein said relation information includes user position information indicating at least one of a locus of a position at which said user transmits said update information through said information terminal and a position at which said user is located, and an indication position information indicating a position which said user indicates through said information terminal, and
when receiving said update information from said information terminal, said providing server calculates said information reliability degree based on one of a shortest distance between said user position and said indication position and a fact whether or not said user can be moved to said indication position from said user position in said shortest distance.

4. An information providing server comprising:
a provider section which provides provision information for an information terminal belonging to a user by transmitting said provision information through a network;
a provision database which stores said provision information;
wherein when receiving an update information which is for updating said provision information and includes relation information related to said user from said information terminal, said providing section calculates an information reliability degree indicating a degree of a reliability of said update information based on at least one of said relation information and said update information, and
said providing section updates said provision information based on said information reliability degree and said update information.

5. The information providing server according to claim 4, wherein said provision information is map information related to a map.

6. The information providing server according to claim 5, wherein said relation information includes user position information indicating at least one of a locus of a position at which said user transmits said update information through said information terminal and a position at which said user is located, and an indication position information indicating a position which said user indicates through said information terminal, and
said providing section calculates said information reliability degree based on one of a shortest distance between said user position and said indication position and a fact whether or not said user can be moved to said indication position from said user position in said shortest distance, when receiving said update information from said information terminal.

7. The information providing server according to claim 6, further comprising:
a positional correlation value database which relates said shortest distance and a positional correlation value;
wherein said positional correlation value is a value indicating said correlation between said user position and said indication position, and
said providing section refers to said positional correlation value database and calculates said information reliability degree, when receiving said update information from said information terminal.

8. The information providing server according to claim 5, further comprising:
a user reliability information database which relates said user identifier to identify said user and a user reliability degree indicating a degree of a reliability of said user;
wherein said relation information includes said user identifier, and
said providing section refers to said user reliability information database and calculates said information reliability degree.

9. The information providing server according to claim 5, further comprising:
an update content reliability information database which stores an information reliability history of said update information in order to update said provision information;
wherein providing section refers to said update content reliability information database, calculates said information reliability degree, and then updates said provision information based on said information reliability degree and said update information, when receiving said update information from said information terminal.

10. The information providing server according to claim 9, wherein said provider section calculates said information reliability degree based on a similarity between said provision information and said update information, and
said information reliability degree is increased or decreased based on said similarity.

11. The information providing server according to claim 10, wherein said update information further includes a content information indicating a content,
said update content reliability information database stores a content information number and said content information correlated to said information reliability history,
said similarity indicates a degree of said similarity between said provision information and said content information,
said provider section increases said content information number, and refers to said update content reliability information database, and then calculates said information reliability degree, when receiving said update information having said content information similar to said provision information from said information terminal.

12. The information providing server according to claim 9, further comprising:
an user reliability information database which relates a user reliability history and said user identifier in order to identify said user;
wherein said user reliability history is said history of said user reliability indicating said degree of said reliability of said user,
said relation information includes said user identifier, and
said provider section further refers to said user reliability information database, and calculates said information reliability degree so that said information reliability degree is reflected in said user reliability history.

13. The information providing server according to claim 5, wherein said provider section transmits said updated provision information to said information terminal, and
said updated provision information includes an update reliability degree indicating said degree of said reliability of said updated provision information.

14. The information providing server according to claim 13, wherein said updated provision information includes an icon corresponding to said update information, and is displayed on said information terminal, and
said update reliability degree is displayed on said information terminal through varieties of one of said icon and color around said icon.

15. The information providing server according to claim 13, wherein said updated provision information includes said icon corresponding to said update information, and is displayed on said information terminal, and
said update reliability degree is displayed on said information terminal by using at least one of a numeral and a character that are related to said icon.

16. The information providing server according to claim 12, wherein said provider section transmits an update report indicating that said provision information was updated, to said information terminal of said user related to said update information.

17. The information providing server according to claim 16, wherein said related user is said user located at one of said indication position included in said update information and a vicinity of said indication position,
said provider section obtains said user position of said related user from said information terminal of said related user, and
said provider section refers to said user reliability information database, and transmit said update report to said information terminal of said related user, when said user position represents one of said indication position and said vicinity thereof.

18. The information providing server according to claim 16, wherein said related user is said user who transmits to said provider section said update information having said user identifier with regard to said provision information through said information terminal,
said provision information relates said user identifier to said information reliability history and stores in said update content reliability information database, and
said provider section refers to said update content reliability information database and thereby transmits said update report to said information terminal of said related user, when said provision information is updated.

19. The information providing server according to claim 16, wherein said related user is said user who preliminarily transmites to said provider section a reception request indicating that said related user requests to receive said update report with regard to said provision information through said information terminal,
said provider section relates said user identifier of said related user requesting said reception request of said provision information in advance to said reception request, and stores said reception request in said user reliability information database, when said related user requests said reception request in advance, and
said provider section refers to said user reliability information database and thereby transmits said update report to said information terminal of said related user, when said update information is updated.

20. The information providing server according to claim 5, wherein said provider section sets in advance a setting reliability degree as a threshold with respect to said information reliability degree in order to update said provision information, and updates said provision information when said information reliability degree exceeds said setting reliability degree.

21. An information providing method comprising the steps of:
(a) providing provision information stored in a provision database for an information terminal belonging to a user by transmitting said provision information through a network;
(b) when receiving an update information which is for updating said provision information and includes relation information related to said user from said information terminal, calculating an information reliability degree indicating a degree of a reliability of said update information based on at least one of said relation information and said update information; and
(c) updating said provision information based on said information reliability degree and said update information.

22. The information providing method according to claim 21, wherein said provision information is map information related to a map.

23. The information providing method according to claim 22, wherein said relation information includes user position information indicating at least one of a locus of a position at which said user transmits said update information through said information terminal and a position at which said user is located, and an indication position information indicating a position which said user indicates through said information terminal, and
in said step (b), said information reliability degree is calculated based on one of a shortest distance between said user position and said indication position and a fact whether or not said user can be moved to said indication position from said user position in said shortest distance, when receiving said update information from said information terminal.

24. The information providing method according to claim 23, wherein said information reliability degree is calculated based on a positional correlation value database, when receiving said update information from said information terminal in said step (b),
said positional correlation value database relates said shortest distance and a positional correlation value, and
said positional correlation value is a value indicating said correlation between said user position and said indication position.

25. The information providing method according to claim 22, wherein said relation information includes said user identifier, and
said information reliability degree is calculated based on a user reliability information database which relates said user identifier to identify said user and a user reliability degree indicating a degree of a reliability of said user in said step (b).

26. The information providing method according to claim 22, wherein when receiving said update information from said information terminal, said information reliability degree is calculated based on an update content reliability information database which stores an information reliability history of said update information in order to update said provision information in said step (b), and
said provision information is updated based on said information reliability degree and said update information in said step (c).

27. The information providing method according to claim 26, wherein said information reliability degree is calculated based on a similarity between said provision information and said update information, and
said information reliability degree is increased or decreased based on said similarity.

28. The information providing method according to claim 27, wherein said update information further includes a content information indicating a content,
said update content reliability information database stores a content information number and said content information correlated to said information reliability history,
said similarity indicates a degree of said similarity between said provision information and said content information, and
said content information number is increased, and said information reliability degree is calculated based on said update content reliability information database, when receiving said update information having said content information similar to said provision information from said information terminal in said step (b).

29. The information providing method according to claim 26, wherein said relation information includes said user identifier,
said information reliability degree is calculated further based on an user reliability information database which relates a user reliability history and said user identifier in order to identify said user in said step (b),
said user reliability history is said history of said user reliability indicating said degree of said reliability of said user, and
said information reliability degree is reflected in said user reliability history.

30. The information providing method according to claim 22, wherein said updated provision information from said step (c) is transmitted to said information terminal in said step (a), and
said updated provision information includes an update reliability degree indicating said degree of said reliability of said updated provision information.

31. The information providing method according to claim 30, wherein said updated provision information from said step (c) includes an icon corresponding to said update information, and is displayed on said information terminal, and
said update reliability degree is displayed on said information terminal through varieties of one of said icon and color around said icon.

32. The information providing method according to claim 30, wherein said updated provision information from said step (c) includes said icon corresponding to said update information, and is displayed on said information terminal, and
said update reliability degree is displayed on said information terminal by using at least one of a numeral and a character that are related to said icon.

33. The information providing method according to claim 29, wherein an update report indicating that said provision information was updated is transmitted to said information terminal of said user related to said update information in said step (a).

34. The information providing method according to claim 33, wherein said related user is said user located at one of said indication position included in said update information and a vicinity of said indication position, and
said user position of said related user is obtained from said information terminal of said related user, and said update report is transmitted based on said user reliability information database to said information terminal of said related user, when said user position represents one of said indication position and said vicinity thereof in said step (a).

35. The information providing method according to claim 33, wherein said related user is said user who transmits to said provider section said update information having said user identifier with regard to said provision information through said information terminal,
said user identifier is related to said information reliability history and is stored in said update content reliability information database in said step (b), and
said update report is transmitted to said information terminal of said related user based on said update content reliability information database in said step (a), when said provision information is updated in said step (c).

36. The information providing method according to claim 33, wherein said related user is said user who preliminarily transmits to said provider section a reception request indicating that said related user requests to receive said update report with regard to said provision information through said information terminal,
said reception request is related to said user identifier of said related user requesting said reception request of said provision information in advance, and is stored in said user reliability information database in said step (b), when said related user requests said reception request in advance, and
said update report is transmitted to said information terminal of said related user based on said user reliability information database in said step (a), when said update information is updated in said step (c).

37. The information providing method according to claim 22, wherein a setting reliability degree as a threshold with respect to said information reliability degree in order to update said provision information is set in advance, and said provision information is updated when said information reliability degree exceeds said setting reliability degree in said step (c).

38. A computer program product embodied on a computer-readable medium and comprising code that, when executed, causes a computer to perform the following:
(d) providing provision information stored in a provision database for an information terminal belonging to a user by transmitting said provision information through a network;
(e) when receiving an update information which is for updating said provision information and includes relation information related to said user from said information terminal, calculating an information reliability degree indicating a degree of a reliability of said update information based on at least one of said relation information and said update information; and
(f) updating said provision information based on said information reliability degree and said update information.

39. The computer program product according to claim 38, wherein said provision information is map information related to a map.

40. The computer program product according to claim 39, wherein said relation information includes user position information indicating at least one of a locus of a position at which said user transmits said update information through said information terminal and a position at which said user is located, and an indication position information indicating a position which said user indicates through said information terminal, and
in said step (e), said information reliability degree is calculated based on one of a shortest distance between said user position and said indication position and a fact whether or not said user can be moved to said indication position from said user position in said shortest distance, when receiving said update information from said information terminal.

41. The computer program product according to claim 40, wherein said information reliability degree is calculated based on a positional correlation value database, when receiving said update information from said information terminal in said step (e),
said positional correlation value database relates said shortest distance and a positional correlation value, and
said positional correlation value is a value indicating said correlation between said user position and said indication position.

42. The computer program product according to claim 39, wherein said relation information includes said user identifier, and
said information reliability degree is calculated based on a user reliability information database which relates said user identifier to identify said user and a user reliability degree indicating a degree of a reliability of said user in said step (e).

43. The computer program product according to claim 39, wherein when receiving said update information from said information terminal, said information reliability degree is calculated based on an update content reliability information database which stores an information reliability history of said update information in order to update said provision information in said step (e), and
said provision information is updated based on said information reliability degree and said update information in said step (f).

44. The computer program product according to claim 43, wherein said information reliability degree is calculated based on a similarity between said provision information and said update information, and
said information reliability degree is increased or decreased based on said similarity.

45. The computer program product according to claim 44, wherein said update information further includes a content information indicating a content,
said update content reliability information database stores a content information number and said content information correlated to said information reliability history,
said similarity indicates a degree of said similarity between said provision information and said content information, and
said content information number is increased, and said information reliability degree is calculated based on said update content reliability information database, when receiving said update information having said content information similar to said provision information from said information terminal in said step (e).

46. The computer program product according to claim 43, wherein said relation information includes said user identifier,
said information reliability degree is calculated further based on an user reliability information database which relates a user reliability history and said user identifier in order to identify said user in said step (e),
said user reliability history is said history of said user reliability indicating said degree of said reliability of said user, and
said information reliability degree is reflected in said user reliability history.

47. The computer program product according to claim 39, wherein said updated provision information from said step (f) is transmitted to said information terminal in said step (d), and
said updated provision information includes an update reliability degree indicating said degree of said reliability of said updated provision information.

48. The computer program product according to claim 47, wherein said updated provision information from said step (f) includes an icon corresponding to said update information, and is displayed on said information terminal, and
said update reliability degree is displayed on said information terminal through varieties of one of said icon and color around said icon.

49. The computer program product according to claim 47, wherein said updated provision information from said step (f) includes said icon corresponding to said update information, and is displayed on said information terminal, and
said update reliability degree is displayed on said information terminal by using at least one of a numeral and a character that are related to said icon.

50. The computer program product according to claim 46, wherein an update report indicating that said provision information was updated is transmitted to said information terminal of said user related to said update information in said step (d).

51. The computer program product according to claim 50, wherein said related user is said user located at one of said indication position included in said update information and a vicinity of said indication position, and said user position of said related user is obtained from said information terminal of said related user, and said update report is transmitted based on said user reliability information database to said information terminal of said related user, when said user position represents one of said indication position and said vicinity thereof in said step (d).

52. The computer program product according to claim 50, wherein said related user is said user who transmits to said provider section said update information having said user identifier with regard to said provision information through said information terminal,
said user identifier is related to said information reliability history and is stored in said update content reliability information database in said step (e), and
said update report is transmitted to said information terminal of said related user based on said update content reliability information database in said step (d), when said provision information is updated in said step (f).

53. The computer program product according to claim 50, wherein said related user is said user who preliminarily transmits to said provider section a reception request indicating that said related user requests to receive said update report with regard to said provision information through said information terminal,
said reception request is related to said user identifier of said related user requesting said reception request of said provision information in advance, and is stored in said user reliability information database in said step (e), when said related user requests said reception request in advance, and
said update report is transmitted to said information terminal of said related user based on said user reliability information database in said step (d), when said update information is updated in said step (f).

54. The computer program product according to claim 39, wherein a setting reliability degree as a threshold with respect to said information reliability degree in order to update said provision information is set in advance, and said provision information is updated when said information reliability degree exceeds said setting reliability degree in said step (f).

55. An information terminal used by a user and connected to a provider server through a network comprising:
a first screen portion which displays provision information received from said provider server;
a second screen portion which displays at least one of a plurality of symbols and a plurality of icons to update said provision information in said first screen portion; and
a control section which updates provision information in said first screen portion based on inputted at least one of said plurality of symbols and said plurality of icons and generates update information including an updated data corresponding to said update and relation information related to said user; and
a transmitting section which transmits said update information to said provider server;
wherein said provider server updates said provision information in said provider server based on said update information.

56. The information terminal according to claim 55, wherein said relation information includes user position information indicating at least one of a locus of a position at which said user transmits said update information through said information terminal and a position at which said user is located, and an indication position information indicating a position which said user indicates through said information terminal, and
said provision information is map information related to a map.
